(19) United States
(12) Patent Application Publication
(10) Pub. No.: US 2011/0055172 A1
(43) Pub. Date: Mar. 3, 2011

(54) AUTOMATIC ERROR CORRECTION FOR INVENTORY TRACKING AND MANAGEMENT SYSTEMS USED AT A SHIPPING CONTAINER YARD

(75) Inventors: Han-Shue Tan, Concord, CA (US); Ke-Ren Chuang, Pleasanton, CA (US); Jihua Huang, Richmond, CA (US); Gregory Keith Warf, Fairfield, CA (US)

(73) Assignee: CONTAINERTRAC, INC., Emeryville, CA (US)

(21) Appl. No.: 12/649,149

(22) Filed: Dec. 29, 2009

Related U.S. Application Data
(63) Continuation-in-part of application No. 12/552,109, filed on Sep. 1, 2009.

(51) Int. Cl. G06F 17/30

(52) U.S. Cl. 707/692; 707/769; 707/E17.014

(57) ABSTRACT

A method automatically detects and corrects errors in a container inventory database associated with a container inventory tracking system of a container storage facility. A processor in the inventory tracking system performs a method to detect errors; this method of error detection obtains a first data record, identifies an event (e.g., pickup or drop-off of a container, or movement of handing equipment) associated with the first record, provides a list of error types based on the identified event, and determines whether a data error has occurred through a checking process. To correct the errors, this method further sets search criteria based on the error detection results, queries the inventory tracking database using the set criteria, determines error candidates based on the query results, evaluates the error candidates to identify a match or matches among the error candidates, and corrects the error(s) by modifying the error detection results together with the identified match or matches.

### CLAIM FOR PRIORITY

This application is a continuation-in-part of application Ser. No. 12/552,109, filed on Sep. 1, 2009, the entire contents of which are incorporated herein by reference.

### BACKGROUND

1. Technical Field

The present invention relates to the detection and correction of errors in the location of containers in a container shipping yard. More particularly, the present invention relates to the detection and correction of inventory data errors in inventory tracking databases and/or systems indicating the location of the containers.

2. Related Art

Over the past decade, shipping container handling volumes have been increasing dramatically. Such increases in handling volume are adversely affecting real-time order visibility. Every partner to the transactions needs to have access to location information throughout a container's journey. However, in port, containers are routinely not visible to the consignees.

Operations on a shipping container generally include out-gate operations, in-gate operations, and yard operations. These operations are conducted by people including a yard clerk, an operator of transport equipment, and an operator of lift equipment. The transport equipment (or yard tractor) refers to any type of handling equipment (HE) that is capable of moving a container from one location to another but is not capable of lifting the container and setting it down. The lift equipment refers to any type of HE that is capable of lifting a container and setting it down on the ground, on top of another container, or onto another HE for transportation. For convenience herein, the term yard tractor and container handling equipment (CHE) will be used to refer to transport equipment and lift equipment, respectively. Among the operations performed, yard operations (operations in a shipping container yard) are the most time consuming in overall average transactions. Traditionally during yard operations, a yard clerk must accompany the CHE operator to validate the correct container for pick-up. If the container is not where it is supposed to be, the typical yard clerk wanders around the yard looking for it. When the yard clerk finds it, both the yard tractor driver and the CHE operator who picks up and loads the container onto the yard tractor must be radioed to come to the new location. Even so, the right container might be buried by others that need to be moved out of the way by the CHE operator, all while the yard clerk and yard tractor driver are waiting. It would be more efficient if the CHE operator could have the container free to load and in a verified location by the time the yard tractor arrives.

To improve the efficiency of container terminals material handling processes, inventory tracking systems have been developed to track and monitor what really takes place in the yard. Such inventory tracking systems typically employ both real-time positioning technology (such as RFID, GPS, and radio beacons) and wireless communication technologies. These systems enable active tracking of the location of the containers (typically by tracking the movement and location of the various pieces of HE that move the containers), report the tracking information to an inventory tracking database, and interface with a Terminal Operating System (TOS) to update container locations whenever an HE picks up or sets down a container. These inventory tracking systems target to improve the accuracy of the container yard inventory and thereby reduce lost containers, maximize TOS performance, and improve the efficiency of HEs.

Ideally, if the real-time positioning systems can achieve 100% positioning accuracy and if the wireless communication system has zero loss and noise, the inventory tracking systems could indeed achieve 100% accuracy in container inventory locations. However, in reality, inventory errors occur due to sensor biases and noise, communication loss and errors, as well as component or system faults and operational errors.

The prior art inventory tracking systems employ a traditional approach in error handling that relies heavily on operators of HEs to detect and report errors as well as error types. When a CHE operator receives a task (from the TOS through its interface with the inventory tracking system) with a pickup location (sometimes called source location), a container ID, and a drop location (i.e., target location), he drives the CHE to the pickup location to pick up the specified container and then drives to the drop location to place the container at the drop location. The prior art inventory tracking system compares the actual pickup location with the specified pickup location, and the actual drop location with the specified drop location; if there is a discrepancy, the system warns the driver and the driver has to report the error unless the driver made a mistake during the operation. Other than that, it is up to the driver to report errors as he tries to carry out the operation.

For example, if there is no such container at the specified pickup location or the CHE cannot get to the pickup location due to obstructions, the CHE operator needs to report the error using the user interface installed in the CHE and the system will then cancel the task and go to the next task. If the specified container is actually located in a neighboring location, e.g., located beneath the specified pickup location with containers on top of it (containers are typically stacked on top of one another), the CHE operator has to pick the container up at the actual pickup location, which is different from the specified pickup location. Since the system compares the actual pickup location with the pickup location specified in the task and issues a warning if they are different, the CHE operator will receive a warning and has to report the error to clear the warning signal. When the CHE operator carries a container to the drop location and the drop location is already occupied, the CHE operator has to report the error and request the system to re-determine the drop location. On the other hand, if there is no container immediately under the drop location as specified in drop location instructions, the CHE operator will have to drop the container at a location lower than the specified drop location, which will trigger the system to warn the driver of incorrect operation. In this case, the CHE operator must report the error again.

Such a traditional manual-heavy approach employed by the prior art has several drawbacks. First, since the system only concerns itself with the pickup and drop locations, the types of errors detected are limited. Second, inventory errors can only be detected and corrected when the system comes to assign a task that involves an incorrect inventory record; consequently, inventory errors can propagate without detection and can cause erroneous reporting of neighboring inventories. Third, this approach requires CHE operators' input for error detection and error correction, which creates additional workload for CHE operators, slows down their operations, and wastes precious resources in terms of both CHEs' and CHE operators' time. Fourth, human beings can make mistakes and this approach is vulnerable to errors in CHE operators' inputs. Consequently, CHE operators must input additional information for error correction, or additional personnel must go to the reported locations for manual error correction.

### SUMMARY

In accordance with embodiments of the present invention, a system is provided for detecting and correcting errors in a container inventory database that improves data quality relative to previous systems by checking and validating inventory data that is reported to or already in the inventory database. The system automatically detects data errors in the inventory database by examining the incoming data records with the data records in the inventory database for any inconsistency or data conflicts, and reports data errors whenever data conflicts are detected. Furthermore, the system performs automatic error correction by examining the error detected with the containers and operations related to surrounding container cell locations, identifying error candidates based on the surrounding containers and relevant operations, evaluating the error candidates to determine a match (or matches) for error correction, and modify the relevant data records to correct the error. Hence, the system can effectively mitigate the propagation of data errors in the inventory database, thereby reducing the occurrence of data errors and improving the quality of the inventory database. Subsequently, the HE operators will encounter significantly fewer errors during operation, which helps relieve them of the additional workload associated with error reporting and reduces the time wasted in searching for the correct locations of containers.

The system includes at least one processing device that performs error detection in the inventory data in an error detection method that first obtains at least one first data record from one of the following sources: the container inventory tracking system, an inventory management system associated with the inventory tracking system, an input device for accepting entries from an operator, and a computer program that generates data records. The method then identifies an event among a pre-defined set of events based on the first data record. The pre-defined set of events represents operations associated with container inventories and HEs in the facility. Examples of such operations include container pickup operations, container drop-off operations, and vehicle movement operations where an HE is moving.

The error detection method further provides a list of error types based on the identified event and determines whether a data error has occurred through a process that uses a computer processor which checks each error type. In each of the checking steps, the processor selects an error type from the list of error types, determines a search criterion based on the selected error type and the first data record, queries the database using the determined search criterion, and obtains query results from the database. The query results are then compared with the first data record to detect data conflicts, and upon the detection of a data conflict reports that a data error of the selected error type has been detected. Thus, this method detects data errors automatically without direct operator involvement.

In one embodiment, upon the detection of the data errors, the processor further identifies, among the data records in the query results, data records that are affected by the data conflicts. The identified data records are referred to as the second data records, and these second data records, together with the first data record, are regarded as erroneous data records. The processor also reports the erroneous data records to at least one of the following: the container inventory tracking system, and an output means for displaying the erroneous data records to an operator. Thereafter, the erroneous data records can be further analyzed for error correction.

Upon the detection of the data errors, the processor further performs error correction in the erroneous data records in an error detection method that first obtains the erroneous data records, which include the first data record and a set of the second data records. Since the detection of the error indicates the first data record and the set of second data records are in conflict with each other, one of the two must contain the error. In order to make the correction, the processor needs to first determine which one needs to be corrected and how to correct it.

In one embodiment, the processor then sets a first search criterion based on the first data record and a set of second search criteria with one second criterion corresponding to each of the second data records, queries the container inventory database with the set search criteria, and obtains first query results corresponding to the first data records and second query results corresponding to the set of second data records. The first query results are then analyzed and evaluated to determine a first match for the first data record, where the first match is a data record among the first query results and modifying the first data record based on the match can remove the error. Similarly, the second query results for each second data record are evaluated to determine a second match for each second data record. The first match and the set of second matches are then compared to determine whether the first data record or the set of second data records should be corrected. If the decision is to correct the first data record, the processor then modifies the first data record based on the first match and if necessary the processor also modifies the match accordingly. If the decision is to correct the second data records, the processor then modifies each of the second data records based on its corresponding match and if necessary the processor also modifies the corresponding match accordingly. Finally, the processor reports the modified data records to the inventory tracking database.

In another embodiment, the error correction method is also used to correct any single erroneous data record. In this embodiment, the process obtains a first data record which has been determined to container an error and needs to be corrected. The processor then sets a search criterion based on the first data record; the search criterion specifies one of the following information: container IDs, container properties, container cell locations, and a time duration. Subsequently, the processor queries the inventory tracking database with the search criterion, obtains the query results, and evaluates the query results to determine a match for the first data record. The processor then modifies the first data record based on the match and if necessary, the processor also modifies the match accordingly. The modified data records are then reported to the inventory tracking database. Thus, the error in the first data record has been corrected.

The error correction method can further an exception process to handle cases where the processor cannot determine which one of the first data record and the second data records should be corrected or where the processor cannot determine how to make the corrections. Such cases could occur under any of the following exception rules is satisfied: (1) when the query yield no results or yield insufficient results, (2) no first match or multiple first matches are identified, (3) no match or multiple second matches are identified for any of the second data records, (4) the comparisons of the first match and the second matches cannot lead to a decision regarding which one the first data record and the second data records should be corrected, and so no. The processor executes the exception process whenever an exception rule is satisfied.

In one simple embodiment, the exception process simply includes modifying certain fields in the first data record and the second data records (if applicable) to indicate that an exception rule has been satisfied. In another embodiment, the exception process further involves an operator for decision making by preparing and outputting instructions to the operator, accepting and validating inputs from the operator, and determining the corrections requested by the operator according to the inputs. The processor then makes the requested corrections and reporting the modified data records to the inventory tracking database.

By automatically detecting and correcting errors in the inventory data, the automatic error detection and error correction process helps prevent the occurrence and propagation of data errors in the inventory tracking database. Subsequently, the tasks generated by TOS based on the inventory tracking database are more likely to be accurate; therefore, HE operators and other users of the system can focus on completing tasks. Furthermore, the automatic error detection and correction process facilitates the use of analysis tools, including simulation tools and replay tools for error simulation and analysis.

### BRIEF DESCRIPTION OF THE DRAWINGS

Further details of embodiments of the present invention are explained with the help of the attached drawings in which:

FIG. 1 shows a block diagram of a typical prior art inventory tracking and management system.

FIG. 2 is a simplified schematic drawing depicting the physical entity of major components of a typical inventory tracking and management system in a shipping container storage facility that is equipped with such a system.

FIG. 3 shows a block diagram of a first embodiment of an inventory tracking and management system with automatic inventory error detection.

FIG. 4 is a block diagram for a second embodiment of the inventory tracking and management system with automatic inventory error detection, wherein the system further includes a Report module, a Replay module, a Simulation module, and User Interface(s).

FIG. 5A shows a top view, while FIG. 5B shows an end view of rows of container stacks in a container shipping yard, where the container cell locations are labeled with an exemplary Container Cell Naming Convention.

FIG. 6 is a flowchart showing the process involved in one embodiment of the error detection module 302.

FIG. 7 is a flowchart showing the detection of inventory errors according to the types of events that have occurred, wherein the types of events include vehicle movement events, container pickup events, and container drop events. FIG. 7 further includes the process of detecting inventory errors when a vehicle movement event occurs.

FIGS. 8A and 8B illustrate examples of vehicle movement violation and the corresponding inventory error.

FIG. 9 is a flowchart showing the process of detecting inventory errors when a container pickup event occurs.

FIGS. 10A and 10B illustrate examples of inventory errors when container pickup events occur.

FIGS. 11A-11D illustrate examples of inventory errors when a container pickup event occurs.

FIG. 12 is a flowchart showing the process of detecting inventory errors when a container drop event occurs.

FIGS. 13A and 13B illustrate two examples of inventory errors when a container drop event occurs.

FIG. 14 shows a block diagram of an inventory tracking and management system with camera-based error detection for detecting inventory errors, particularly errors in the location of containers in a container shipping yard.

FIG. 15 is a flowchart showing the process of detecting inventory errors based on images from the cameras.

FIG. 16 shows a block diagram for a camera-based inventory error detection system that interfaces with an inventory tracking system for detecting errors in an inventory tracking database associated with the inventory tracking system.

FIG. 17 shows a block diagram of a first embodiment of an inventory tracking and management system with automatic inventory error detection and correction.

FIG. 18 is a flowchart showing one embodiment of the error correction process executed by the Error Correction Module 1702.

FIGS. 19A-19D provide an example to illustrate how one embodiment of the error correction process in FIG. 18 works.

FIG. 20 is a flowchart showing another embodiment of the error correction process executed by the Error Correction Module 1702.

FIG. 21 shows an example to illustrate how to determine a weighting factor used in the computation of confidence indexes.

FIGS. 22A-22D shows an example where four operations were carried out at different time instants and an error was detected for the last operation.

FIG. 23A illustrates the error detected; FIGS. 23B-23E illustrate the four cases in which each of the four error candidates gets to be the match for error correction; FIG. 23F shows the information used to compute the weighting factor in the confidence indexes.

FIG. 24 is a flowchart showing the process involved in one embodiment of the correction exception process in step 1820 and step 2024.

### DETAILED DESCRIPTION

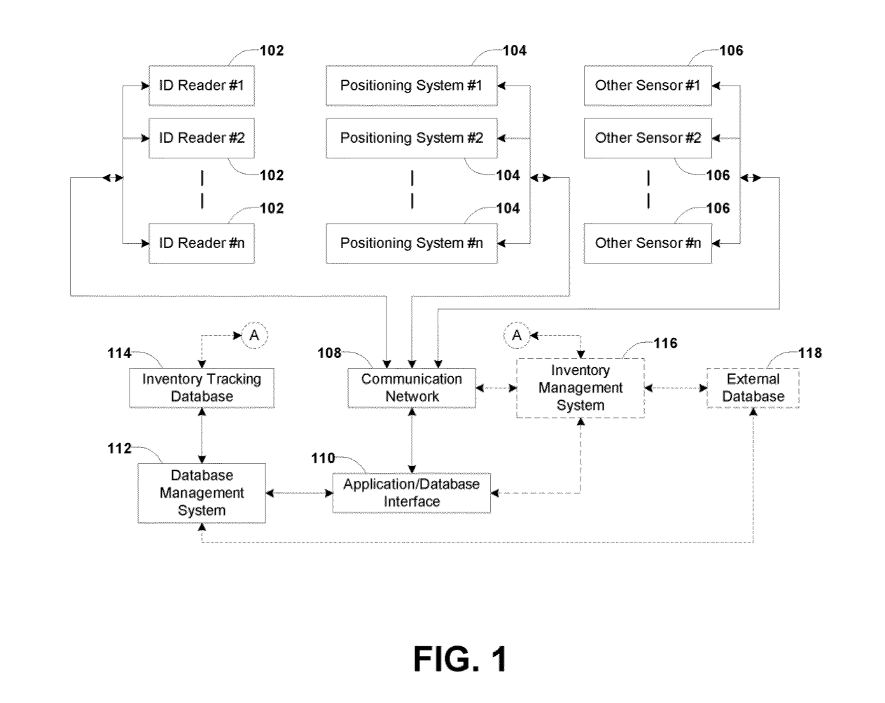

FIG. 1 shows a block diagram of an automatic inventory tracking and management system that includes components used in embodiments of the present invention. The inventory tracking and management system identifies the containers being moved, tracks the movement of Handling Equipment (HE) so as to track the containers, communicates the tracking information, and stores the information of the container storage locations and the movement of the HE.

The system includes ID Readers 102, Positioning Systems 104, Other Sensors 106, a Communication Network 108, an Application/Database Interface 110, a Database Management System 112, and an Inventory Tracking Database 114. The ID Readers 102 are used to detect the presence and the identification number of inventory items and HE; the ID Readers may be in the form of an RFID (Radio Frequency ID) exciter/scanner, a bar code scanner, an OCR (Optical Character Recognition) sensor (e.g., cameras), or any other types of devices used for this purpose. The Positioning Systems 104 determine and/or track the locations of inventories, typically by determining the locations of HE that pick up, move, or place inventory items in an inventory storage location. The Positioning Systems 104 can include one or more of the following: a GPS (Global Positioning System) or a DGPS (Differential GPS), INS (Inertial Navigation System), IMU (Inertial Measurement Unit), RTLS (Real Time Locating System), PDS (Position Detection System), and other sensors and systems known in the art that can be used to determine the location of inventory items or HE. Other Sensors 106 include miscellaneous sensors that support the position tracking or management of inventory operations. The Other Sensors 106 can include one or more of the following: a height sensor, mobile RFID exciter/reader, speed sensor, photo sensor, infra-red sensor, OCR (Optical Character Recognition) sensor, bar code scanner, mechanical switch, electronic switch, and sonic sensor.

The information from the ID Readers 102, Positioning Systems 104, and Other Sensors 106 is transported to the Application/Database Interface 110 through the Communication Network 108. The Communication Network 108 can include one or more of the following: a wireless communications network, a LAN (Local Area Network), and a hard-wired proprietary communication network. The Application/Database Interface 110 provides a software interaction capability between the Database Management System 112 and any software application or service that requires access to the information stored in the Inventory Tracking Database 114 and/or provides information to the Inventory Tracking Database 114. The Database Management System 112 controls the organization, storage, management, and retrieval of data in the Inventory Tracking Database 114, while the Inventory Tracking Database 114 stores records of all inventory items and relevant data associated with the inventory. The relevant data can include one or more of the following: an inventory ID, description, product ID, product name, physical attributes of the inventory item, storage location of the inventory item, date and time of inventory item events (such as when the inventory item was placed into or picked up from a storage location), the type and ID of the HE that moved, picked up, or placed the inventory item, the travel history of the HE and any other vehicle equipped with a Positioning System, or other descriptive characteristics as determined by local practice.

The individual modules in the inventory tracking and management system as shown in FIG. 1 may vary from system to system, and the system may include additional modules/components or may be more compact with functions of different modules combined into fewer modules than depicted. For example, some inventory tracking systems may combine the Inventory Tracking Database 114 and the Database Management System 112 into one Inventory Tracking Database System. Furthermore, the Application/Database Interface 110 can be incorporated into the Inventory Tracking Database System 114, especially when the interface is relatively simple. The Application/Database Interface 110, Database Management System 112 and Inventory Tracking Database 114 can be provided in one or more processing devices such as a computer, a digital signal processor, an FPGA, or a microprocessor. Control code for the one or more processors as well as inventory data can be stored in memory devices provided in the one or more processors or connected to the processors.

Optionally, some inventory tracking and management systems can also contain additional modules such as an Inventory Management System 116 and its associated External Database 118 that includes a typical Terminal Operating System (TOS) used in many seaport container storage yards, inland container yard terminals, and rail intermodal container terminals. Such Inventory Management Systems and External Databases typically contain data associated with the inventory ID, storage location, owner of the container, consignee of merchandise inside the inventoried container, transit information and ships loading information, but they typically do not include information associated with the HE or the movement history of the HE.

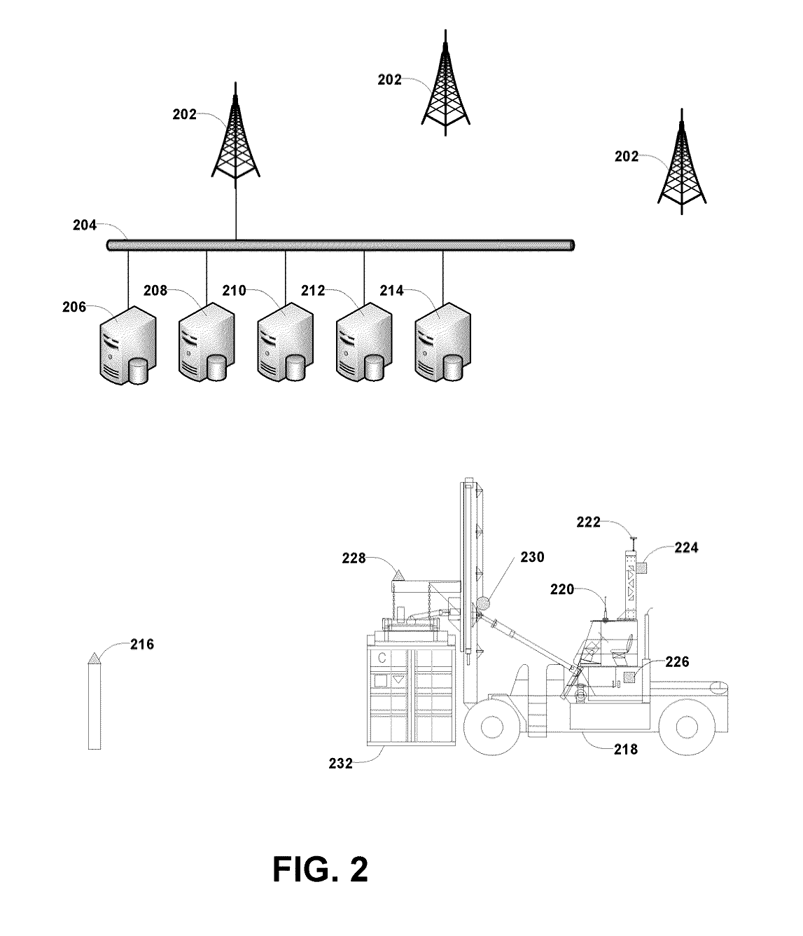

FIG. 2 is a simplified drawing depicting the physical entity of major components of a conventional inventory tracking and management system in a shipping container storage facility. The CHE 218 is a piece of HE that is designed to lift, move and place shipping containers in a shipping container storage facility. Such equipment includes top-picks (or top-lifts), side-picks (or side-lifts, or empty handlers), straddle carriers, reach stackers, rubber tired gantries (RTGs), rail mounted gantries (RMGs), quay cranes, and jockey trucks (also referred to as UTRs, tugs, or yard hustlers). The CHE 218 shown in FIG. 2 is a top-pick. Since this shipping container storage facility is equipped with the inventory tracking system, all HE are equipped with a positioning system that is used to accurately track the location and movement of the HE and thus the shipping containers they move. In this example, the positioning system is made up of a GPS system 222 and an Inertial Measurement Unit (IMU) 224, as well as a processor based unit (CPU) 226 which interfaces with and collects data from the GPS system 222, IMU 224, and other sensors. Other sensors can include a Height Sensor 230 which measures the height at which a shipping container 232 is located when the CHE 218 picks it up or sets it down. The CHE 218 can also be equipped with a mobile ID reader/tag 228, which is detected by fixed ID readers/tags 216 that are installed at specific locations in the shipping container storage facility. As the CHE 218 moves into certain proximity of a fixed ID reader/tag 216, the fixed ID reader/tag 216 detects the presence of the mobile ID reader/tag 228 and thus the presence of the CHE 218, and transmits such information to the application/database interface 206. Alternatively, the mobile ID reader/tag 228 can detect the fixed ID reader/tag 216 when the CHE 218 is close by, and thus provide the CPU 226 additional location-related information to support the positioning of the CHE 218.

The CPU 226 collects the data from all these sensors and uses it to calculate the location of the CHE 218 as the CHE moves about the shipping container storage facility and picks up or sets down a shipping container 232. The CPU 226 also receives information (e.g., engaged or disengaged) from twistlock sensors (a type of switch included in twistlocks that are installed on the spreader bar of the CHE), which indicates the pickup or the drop-off of a shipping container 232. Therefore, the CPU can also determine the location at which the CHE 218 picks up or sets down a shipping container 232. The CHE 218 is further equipped with an onboard communication unit 220, which communicates information from the CPU 226 to other components of the system, including the Application/Database Interface 206, Database Management System 208, Inventory Tracking Database 210, and, optionally, the Inventory Management System 212 and External Database 214, via the Wireless Communication Network 202 and Local Area Network (LAN) 204 similar to the components shown in FIG. 1. The CPU 226 can also receive data, such as instructions that direct the activities of and information requested by the driver of the CHE 218, from those other components via the Wireless Communication Network 202. In addition, the LAN 204 (wired or wireless) provides communication connectivity between the Wireless Communication Network 202, Application/Database Interface 206, Database Management System 208, and Inventory Tracking Database 210. Optionally, the LAN 204 can also connect to the Inventory Management System 212 and External Database 214 to facilitate data or information exchanges between these components. It should be noted that although these components (206, 208, 210, 212, and 214) are drawn as separate physical entities in FIG. 2, some or all of them may reside in the same processing device.

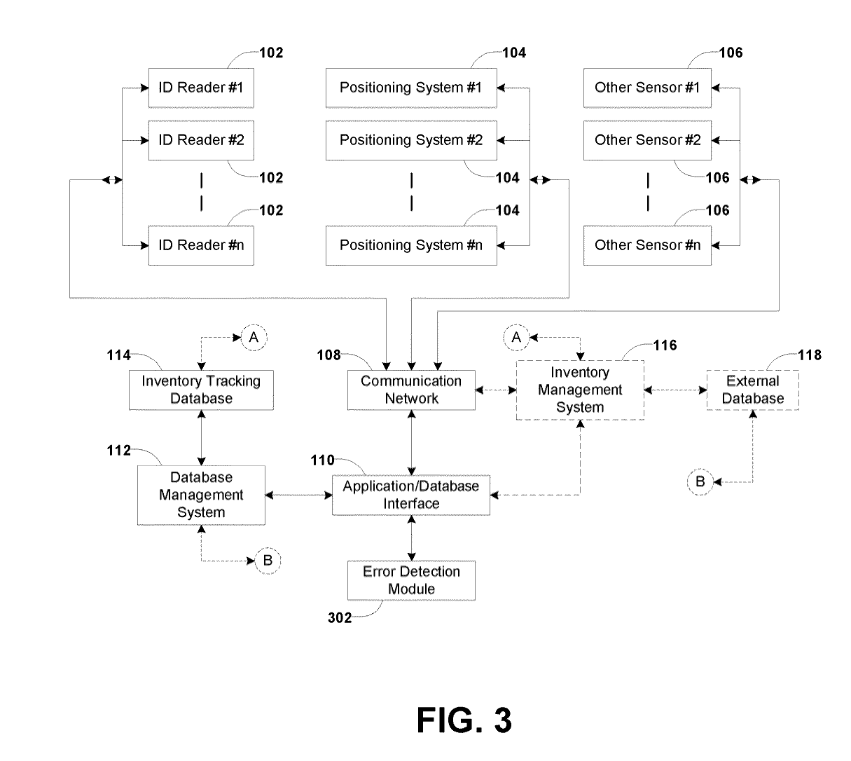

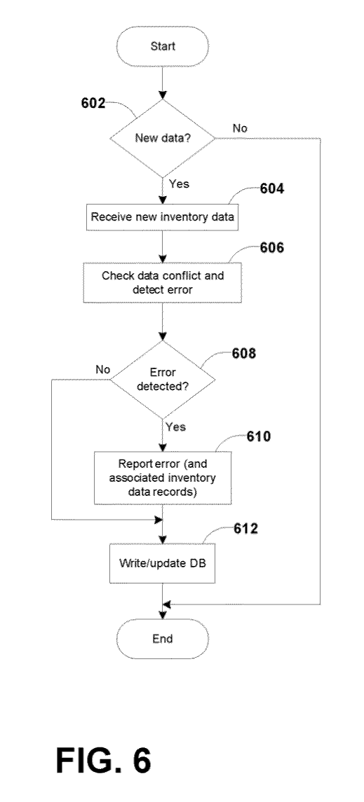

FIG. 3 shows a block diagram of an inventory tracking and management system with automatic inventory error detection components included according to embodiments of the present invention. In addition to the components in a typical inventory tracking and management system as shown in FIG. 1, the system further includes an Error Detection Module 302 that examines the validity of inventory data and automatically detects errors in the inventory tracking database 114. Although manual intervention is not necessary in the automatic error detection process, the Error Detection Module 302 can allow operators to manually intervene in the error detection process if the operators so desire. Details of the Error Detection Module 302 will be described later with respect to FIGS. 6 to 13.

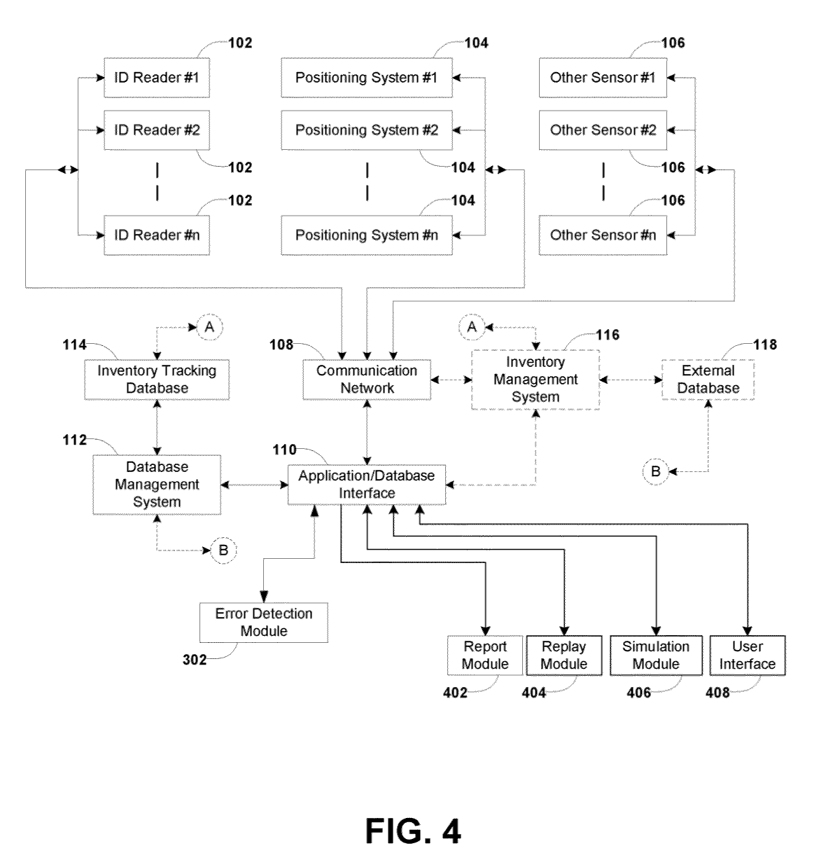

FIG. 4 is a block diagram of another embodiment of components of the inventory tracking and management system according to the present invention. In this embodiment, the system includes the components shown in FIG. 1, as well as the Error Detection Module 302 of FIG. 3. Furthermore, the system includes the following: a Report Module 402, a Replay Module 404, a Simulation Module 406, and a User Interface 408. The Report Module 402 provides users the ability to query the system for particular information and historical data. The Replay Module 404 allows users to select a particular segment in time, a particular vehicle or group of vehicles, a particular shipping container, or other select criteria and have that segment of time “replayed” on a graphical user interface (GUI) (which is part of the User Interface 408) for the purpose of visually following the history of events, which may also facilitate manual evaluation and verification of the results from the automated error detection. The Simulation Module 406 allows users to manually input variable data elements via the User Interface 408 in a “simulation” mode, which would assist users to better understand the effects of various operation sequences and allow users to manually correct the detected errors by trial and error with operations preceding the occurrence, of the errors. The User Interface 408 may be a graphical user interface and one or more input/output device(s), including but not limited to keyboards, printers, mice, or other local or remote input/output device(s).

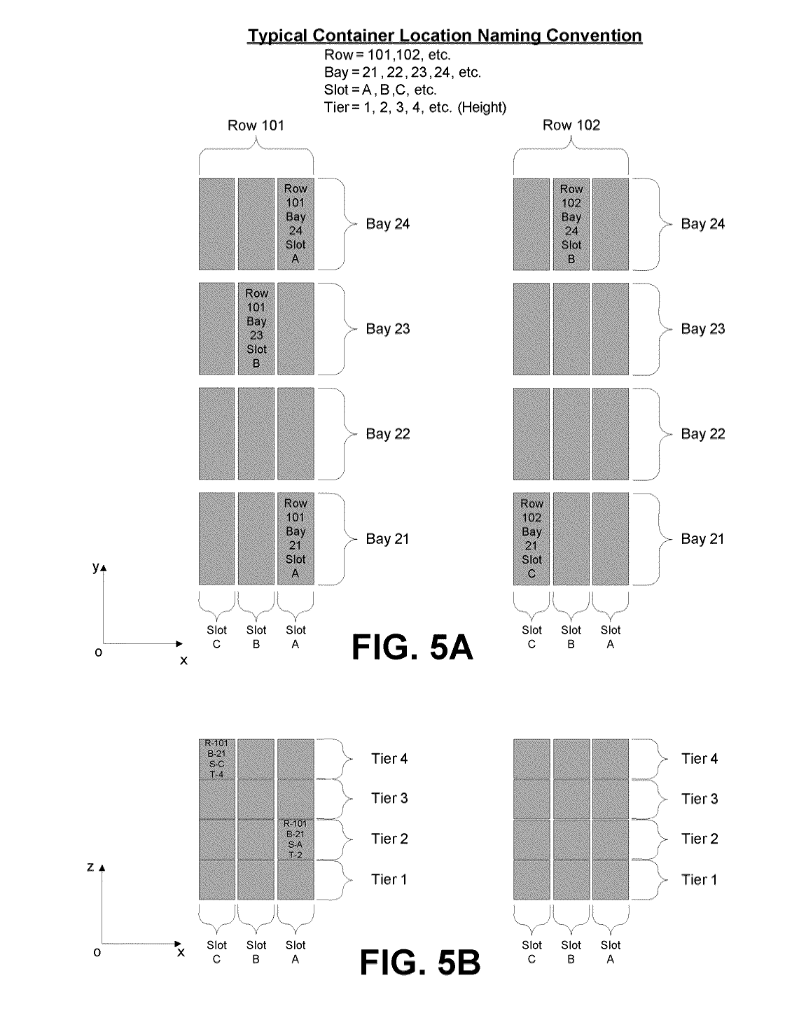

FIGS. 5A and 5B show an exemplary layout of a container storage facility, at either a seaport terminal, a rail intermodal terminal, or an inland storage terminal. A Top View (FIG. 5A) and an End View (FIG. 5B) are included to illustrate the three-dimensional characteristics of the storage locations at a storage facility (terminal). Each individual rectangular block represents a container storage location where a container can reside. To uniquely identify each container storage location in the container storage facility, location naming conventions are usually used. FIGS. 5A and 5B show a typical location naming convention, which uses terms such as Row, Slot, Bay, and Tier. In this naming convention, a Slot value and a Bay value are used to uniquely identify a container storage location's planetary position in the container storage facility. Each bay has the width of one container's length and each slot has the width of one container's depth. Typically, several Slots (3 Slots in the example shown in FIG. 4) are grouped together to form a Row, and the distance between Rows is kept much larger than that between Slots in a Row so as to allow enough space for an HE to maneuver through. Containers can also be stacked on top of one another, and the height of the container storage location is represented by a Tier value. In the Top View (FIG. 5A), the container storage location in the far lower right corner of Row 101 is represented as (Row 101, Bay 21, Slot A) for its planetary position. In the End View (FIG. 5B), the height is shown and the container cell on the second tier of location (Row 101, Bay 21, Slot A) is uniquely identified by (Row 101, Bay 21, Slot A, Tier 2). Such a cell-naming convention allows quick and easy identification of a storage location for containers as well as numerous other types of inventory. Other naming conventions can also be used, and they all reflect uniformity throughout the storage facility in representing the three-dimensional storage cell locations.

The naming conventions typically identify the logical position of each container storage location, which may not be readily measured; for example, a GPS-based positioning system provides longitudinal, lateral and altitude positions in earth coordinates based on the pseudo-range (the distance between the satellite and the antenna) measurements from the GPS receiver. To facilitate the association of the positions from the positioning system with the logical positions represented in the naming conventions, the positioning system further transforms its position measurements in earth coordinates to positions in local Cartesian coordinates (x, y, z) as shown in FIGS. 5A and 5B. Subsequently, a conversion table is typically used to associate the Cartesian positions (i.e., positions in the local Cartesian coordinates) with the logical position of the container cell. An exemplary conversion table is shown below in Table 1, where the Cartesian positions correspond to the Cartesian positions of the center of the container cell. Alternatively, other types of coordinates (such as polar coordinates) can be used and accordingly, conversion tables that associate the logical locations to cell locations in the chosen coordinates are used.

TABLE 1
Exemplary Conversion Table

| | Cartesian positions |
|---|---|
| Logical location | (of the center of the cell location) |
| Row 101, Bay 24, Slot A, Tier 1 | x1, y1, z1 |
| Row 101, Bay 24, Slot A, Tier 2 | x1, y1, z2 |
| . . . | . . . |
| Row 101, Bay 22, Slot A, Tier 1 | x1, y2, z1 |
| . . . | . . . |
| Row 102, Bay 24, Slot C, Tier 4 | x2, y1, z4 |
| . . . | . . . |

Notice that given the local coordinate (x, y, z) as shown in FIGS. 5A and 5B, container cells that are in the same Slot of a Row share the same value in x coordinate, container cells that are in the same Bay share the same value in y coordinate, and container cells that are in the same Tier share the same value in z coordinate. The container storage facility and the naming convention described above together with FIGS. 5A and 5B will be used to help describe the process in the Error Detection Module 302. However, the Error Detection Module 302 can work with other naming conventions.

FIG. 6 is a flowchart illustrating the basic operation of the Error Detection Module 302. The process starts with examining whether new data is available for processing at step 602. In one embodiment, the new data is provided by the inventory tracking system, e.g., it can be generated by the Application/Database Interface 110 based on the information it received from the ID readers 102, Positioning Systems 104, and Other Sensors 106 via Communication Network 108, as well as information from Inventory Management System 116. In an alternative embodiment, the new data can be data records input by an operator through an input means including keyboards, mice, touch screens, and so on. The new data can also be provided by any computer program that generates data records, e.g., any application or service that requests and retrieves data from the Inventory Tracking Database 114. Examples of such applications include validity check programs, simulation tools, replay tools, and so on.

This new data includes at least one data field containing position-related information, which can be either a position of an HE, a position of a container inventory, or a container cell location. The new data should also include sensor information for identifying an event associated with the new data or directly include a data field that specifies the event. The new data can further include data fields containing some of the following information: a time stamp associated with this data, the ID and type of the HE the data is associated with, the movement information of the HE (e.g., speed), the ID and type of the container being operated by the HE, the type of the operation, the confidence level of this data, and so on. For example, the new data may indicate a container with ID as Container A has been picked up at a container cell location (e.g., Row 101, Bay 21, Slot A, Tier 2).

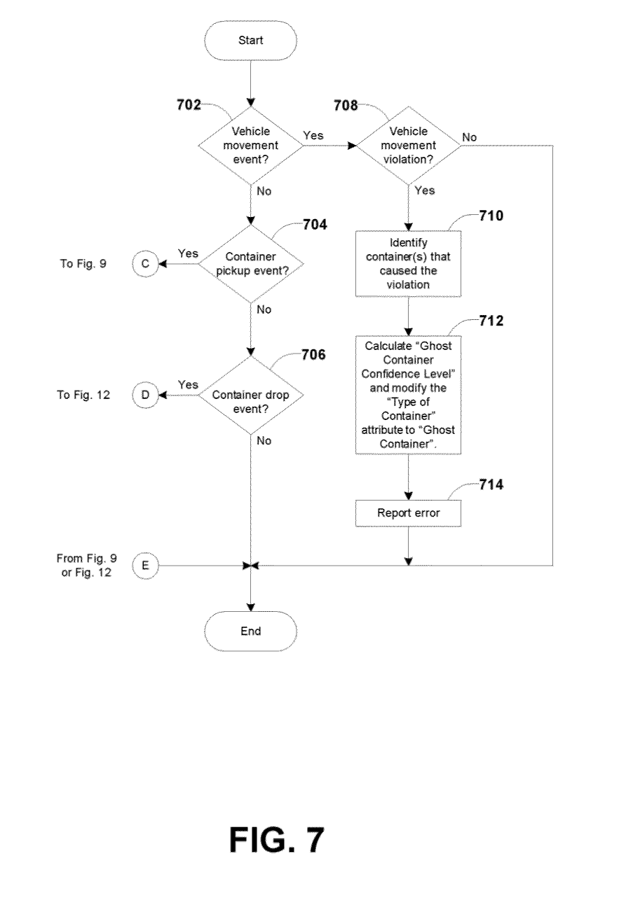

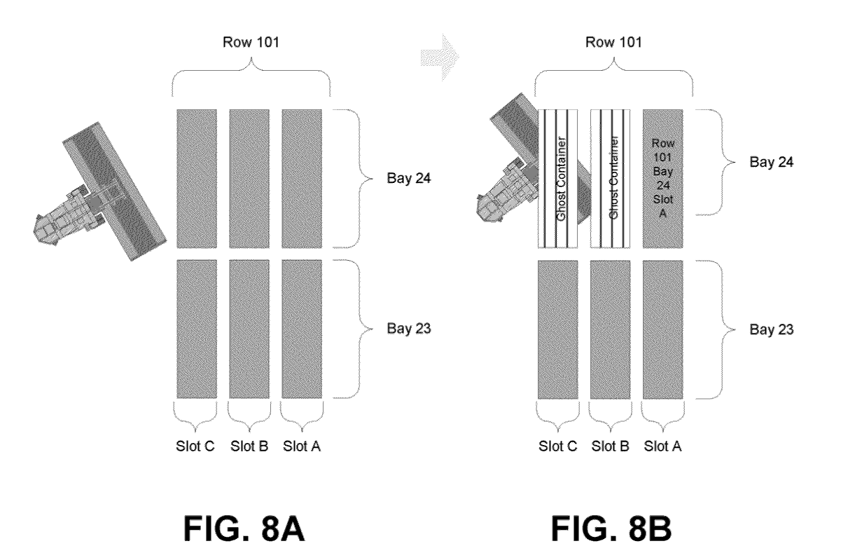

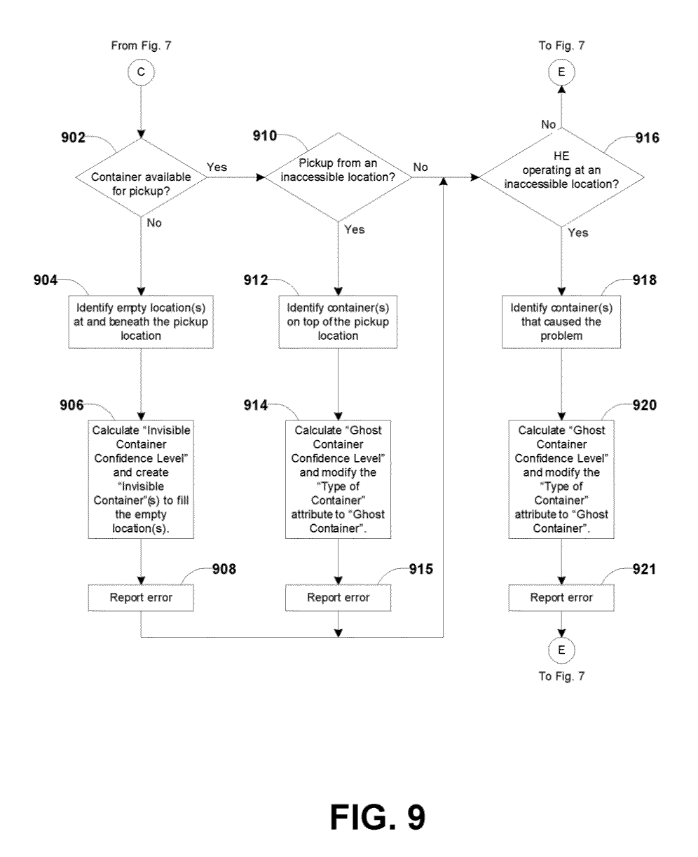

If no new data is available, the Error Detection Module 302 exits the process and waits until the next process cycle to re-enter the process, which will again start with checking for the availability of new data at step 602. If new data is available, the Error Detection Module reads the new data at step 604. At step 606, the Error Detection Module then examines the new data received at step 604 together with the corresponding inventory data it requested from the Inventory Tracking Database for their consistency, so as to detect data conflicts/errors. The detailed data conflict detection process involved in step 606 is described later with respect to FIGS. 7 to 13.

The output of step 606 includes at least one variable indicating whether or not data conflicts/errors have been detected; such variables are used in step 608 to determine the subsequent process. If errors are detected, the Error Detection Module 302 continues to step 610 to report the error back to the Application/Database Interface 110, which can further report the error to users (e.g., through User Interface 408). In other embodiments, the Error Detection Module reports the error to an inventory management system associated with the inventory tracking system, or an output means for displaying the erroneous data records to an operator, or a computer program that is configured to receive the erroneous data records. The Error Detection Module may also request operators to manually correct the errors or it may initiate an automatic error correction process if available. After reporting the error or if no error has been detected, the Error Detection Module continues to step 612 to write/update the Inventory Tracking Database 114 with the (updated) inventory data. In one embodiment, the Error Detection Module also creates tables in the Inventory Tracking Database 114 and the erroneous data records to the tables upon the detection of data errors; thus, the erroneous data records are collected in these tables for easy access by an operator or a computer program. Alternatively, the Error Detection Module 302 may create log data to record additional results generated during the data conflict detection process (step 606) and write such log data into the Inventory Tracking Database 114. The Error Detection Module 302 then exits the process and waits until the next process cycle to repeat the process.

FIG. 7 is a flowchart illustrating one embodiment of the data conflict detection process involved in step 606, where the Error Detection Module 302 compares the new inventory data with the corresponding inventory data from the Inventory Tracking Database 114 to detect data conflicts and, upon the detection of a data conflict, further determines the type of the data conflict and the container(s) that caused the data conflict, calculates confidence levels and indexes, and re-assigns attributes to relevant containers.

In this embodiment, different detection procedures are used to detect data conflicts based on the event associated with the new data. The data conflict detection process first identifies this event from a pre-defined set of events based on the new data. The pre-defined set of events represents operations associated with the inventories and HE. The operations can include the following: container pickup operations where a container inventory is picked up, container drop-off operations where a container inventory is set down, and vehicle movement operations where an HE is moving. Accordingly, the pre-defined set of events includes the following: vehicle movement events (i.e., the HE is moving with a speed larger than a pre-set threshold such as 0.1 m/s), container pickup events (i.e., the HE has just picked up a container), and container drop events (i.e., the HE has just dropped off a container).

Initially in FIG. 7, the data conflict detection process identifies which type of the pre-defined events has occurred in steps 702, 704 and 706. In one embodiment, the new inventory data includes a field (e.g., an “event” field) directly specifying the associated event; for example, a value ‘0’ indicates a vehicle movement event, a value “1” indicates a container pickup event, a value “2” indicates a container drop event, and so on. Correspondingly, the value in the “event” field is examined at step 702 and a vehicle movement event is detected if the value is equal to 0. If the value is not 0, the process continues to step 704 to determine whether a container pickup event has occurred. If the value in the “event” field is equal to 1, a container pickup event is detected; otherwise, the process continues to step 706 to determine whether a container drop event has occurred by examining if the value in the “event” field is equal to 2.

Besides the “0”, “1”, or “2” stored in an inventory data field, in another embodiment, the new inventory data can include a field containing the speed of the HE. If the speed is larger than a pre-set threshold, a vehicle movement event is detected; otherwise, the new inventory data does not indicate a vehicle movement event. Further, the new inventory data can include the output from a field containing sensor (e.g., a twist-lock sensor) or other information that indicates a pickup or drop event. For example, when a container is being picked up, the twist-lock sensor on the HE changes from “unlocked” to “locked,” and when a container is being dropped off, the twist-lock sensor changes from “locked” to “unlocked.” Therefore, in this embodiment, the new inventory data includes information of the change in the twist-lock status and the process examines this information to identify the associated event (pickup or drop event) at steps 704 and 706.

If a container pickup event is detected at step 704, the process continues to steps 902 through 920 in FIG. 9. If instead a container drop event is detected at step 706, the process continues to steps 1202 through 1220 in FIG. 12. If none of the events are detected, this data conflict detection process (which corresponds to the process in block 606) ends after step 706 without reporting any error.

If a vehicle movement event is detected at step 702, the process continues to steps 708 through 714 for data conflict detection. Steps 708 through 714 show the data conflict detection process when a vehicle movement event has been detected at step 702. To help explain the process, two examples of vehicle movement events are provided in FIGS. 8A and 8B that will be described after the description of steps 708 through 714. According to the identified event, the data conflict detection then provides a list of possible error types and employs an error checking process to go through these error types in the list to determine whether an error of the specified error types has occurred. In one embodiment, the list of possible error types corresponding to a vehicle movement event includes movement violation, which can mean the HE is moving at locations that are already occupied by containers according to the inventory database. Since a movement violation is the only error type in the list of error types for vehicle movement events, the error checking process (at step 708) just needs to determine if the movement violation has occurred.

For step 708, the data conflict detection process uses the following procedure for detecting movement violations:

(1) The data conflict detection process first determines a search criterion based on the error type (here, a movement violation) and the new data; more specifically, the process identifies container cell location(s) (i.e., Row, Bay, and Slot values) that corresponds to the position in the new data (with consideration of the dimension of the HE) based on the location-position association described earlier (see Table 1 and the location naming convention in FIGS. 5A and 5B).

(2) If no container cell location is identified, the position is not a container cell location (e.g., the HE is moving along an aisle between two rows), and the data conflict detection process determines that no moving violation has occurred.

(3) If container cell locations are identified, these cell locations constitute the search criterion and the process then queries the inventory database for inventory data corresponding to the identified cell locations. If the query results (i.e., inventory data records) indicate there is a container where one should not be or there are multiple containers at the identified single cell location, the data conflict detection process concludes and reports that a movement violation error has occurred. Otherwise, the data conflict detection process reports that no movement violation has occurred.

After step 708, the process can return directly to steps 608 through 612 to report error or no error depending on the detection at step 708. Alternatively, if a movement violation is detected at step 708, the process can further identify and modify the erroneous data records that are affected by the detected error as shown at steps 710 through 714 in FIG. 7.

At step 710, the data conflict detection process reads the data records in the query results, identifies among them the data records that show the cell locations are occupied, and determines these data records as erroneous inventory data records. Since an HE cannot move through an occupied cell location in reality, a movement violation indicates either the position data in the new inventory data is wrong (i.e., the HE is actually not at the position reported in the new inventory data), or the corresponding inventory data that shows that the cell location is occupied is erroneous (i.e., there is actually no container at the location). In the embodiment shown in FIG. 7, the data conflict detection process always trusts the position data in the new inventory data. Thus, the inventory data that shows that the cell location is occupied is always regarded as erroneous.

At step 712, the data conflict detection process further modifies each of the erroneous inventory data records to indicate an error has occurred. In one embodiment, the modification includes changing an attribute field (referred to as “Type of Container” for description purposes) in an erroneous inventory data record, e.g., to “Ghost Container,” to indicate that the container is a “ghost” in the Inventory Tracking Database 114 and that it does not actually occupy the cell location. The data conflict detection process also modifies the new data, e.g., by adding an error flag to the new data, to indicate that the corresponding movement event causes a movement violation error, thereby the process regards the new data as erroneous data records as well. Such modification facilitates the subsequent error correction process (either manual or automatic) by distinguishing these containers and the corresponding data records from “normal” containers and their records, where no errors have been found. If the subsequent error correction process determines that these containers are actually at the specified location and the new data is actually erroneous, it can delete “Ghost Container” or replace it with a “normal” attribute property in the “Type of Container” data field.

The modification can further include calculating a confidence level, Confₑᵣᵣ, to indicate to what level of confidence the containers in the erroneous data records are indeed ghost containers. Such a confidence level is usually calculated as a function of Confₚₒₛ, the confidence of the position data of the HE provided in the new inventory data: Confₑᵣᵣ=f(Confₚₒₛ). In a simplest embodiment, the confidence level is set to be the confidence of the position data in one embodiment: Confₑᵣᵣ=Confₚₒₛ. Alternatively, the calculation can also use the confidence level (Conf_{drop}) 1 in the erroneous data records, which is the confidence level of the drop event of that container: Confₑᵣᵣ=f(Confₚₒₛ, Conf_{drop}). For example,

$${Conf}_{err} = \frac{{Conf}_{pos} \times ( 1 - {Conf}_{drop} )}{{Conf}_{pos} \times ( 1 - {Conf}_{drop} ) + ( 1 - {Conf}_{pos} ) \times {Conf}_{drop}}$$

After step 712, the data conflict detection process then reports the data conflict as an error (e.g., by setting an error flag to 1) in step 714; the data conflict detection process can further output information such as the modified erroneous inventory data records, the type of error (i.e., ghost containers), and the type of event (i.e., vehicle movement event) at step 714. This information can then be used in the subsequent error reporting process at step 610 in FIG. 6.

To further explain the data conflict detection process shown in FIG. 7, two examples of vehicle movement events are provided in FIGS. 8A and 8B. In the first example shown in FIG. 8A, an HE is approaching the containers in Row 101 according to the positioning system(s) onboard the HE. The sensor information is transmitted periodically via the Communication Network 108 to report the HE's status to the Application/Database Interface 110. Such sensor information can include the position of the HE, the confidence of the position, the speed of the HE, the event associated with the HE, and so on. The Application/Database Interface 110 then generates new inventory data as it deems necessary to write into the Inventory Tracking Database 114 through the Database Management System 112. Meanwhile, the Application/Database Interface 110 also forwards the generated new inventory data to the Error Detection Module 302 for error detection. (Alternatively, the Application/Database Interface may wait until it receives confirmation from the Error Detection Module 302 before it writes the new inventory data to the Inventory Tracking Database 114.) At the time instance corresponding to the first example, the new inventory data indicates the position of the HE as (x, y, z) and the speed as vx, which is greater than 0.1 m/s indicating the container is moving.

As described with FIG. 6, since the speed of the HE is greater than the threshold (e.g., 0.1 m/s), the Error Detection Module determines that the new inventory data indicates a vehicle movement event at step 702. The Error Detection Module then determines whether a moving violation for the HE at its location next to Row 101, Bay 24 has occurred at step 704. To do that, the data conflict detection process first identifies the cell location (i.e., a Row value, a Bay value, and a Slot value) that corresponds to the position in the new inventory data (px, py, pz). Since the HE is a physical entity with dimensions while the position (px, py, pz) typically corresponds to a point on the HE (e.g., the mount location of the GPS receiver onboard the HE), the planetary position (px, py) is usually converted to an area that represents the planetary area the HE occupies. In one embodiment, upper and lower bounds at x and y coordinates are used and the planetary area is represented by ([px−xb1, px+xb2], [py−yb1, py+yb2]), where xb1 and yb1 are the lower bounds and xb2 and yb2 are the upper bounds. The upper and lower bounds can vary depending on factors such as the type of the HE and whether the HE is loaded with a container or not, and the physical dimensions of the container. The data conflict detection process then searches the Cartesian positions in the conversion table (e.g., Table 1), for any Cartesian positions (x, y, z) that satisfies

px−xb1−(width/2)<=x<=px+xb2+(width/2), and

py−yb1−(length/2)<=y<=py+yb2+(length/2),

where width, length, and height are the width, length, and height of a cell location. In this specific example shown in FIG. 8A, the search yields no results since the area ([px−xb1, px+xb2], [py−yb1, py+yb2]) does not correspond to a valid cell location, as the HE is spaced apart from any containers in Row 101, Bay 24. Accordingly, the data conflict detection process concludes that no moving violation occurs at step 708 and exits to step 608 without reporting any error. Subsequently, the process continues to step 612 to update the database.

Assume the HE continues moving and is now at the position shown in FIG. 8B; which is within the area of containers in Row 101, Bay 24. A new inventory data record generated at this time instance now includes the new position (px, py, pz) and a new speed vx that is also larger than the pre-set threshold, indicating the HE is moving. Again, the Error Detection Module 302 determines that a vehicle moving event has occurred at step 702. The Error Detection Module then follows the three-step procedure to determine whether a moving violation has occurred: (1) the process searches the Cartesian positions in the conversion table (e.g., Table 1), for the corresponding cell location, (2) the search now results in (Row 101, Bay 24, Slot C, Tier 1 to Tier 4) and (Row 101, Bay 24, Slot B, Tier 1 to Tier 4), and (3) the process then queries the Inventory Tracking Database 114 for inventory data corresponding to those cell locations (Row 101, Bay 24, Slot C, Tier 1 to Tier 4) and (Row 101, Bay 24, Slot B, Tier 1 to Tier 4).

If the Inventory Tracking Database 114 does not include any records showing containers at the specified cell locations, the query will return no results, or in some Inventory Tracking Systems the query will return records indicating the locations are unoccupied. The Error Detection Module 302 then concludes that no movement violation occurs and exits to step 608 with no error reported. If the Inventory Tracking Database 114 had data records showing there are two containers located at the specified cell locations, for example, Container A at (Row 101, Bay 24, Slot C, Tier 1) and Container B at (Row 101, Bay 24, Slot B, Tier 1), the query will yield the corresponding two inventory data records. According to the query results, the Error Detection Module 302 concludes that there are containers there and therefore a movement violation has occurred. The Error Detection Module 302 then reads the two inventory data records at step 710 for further processing. Subsequently at step 712, the Error Detection Module 302 changes the two inventory data records to mark each of the Containers A and B, e.g., as “Ghost Container,” and updates their confidence level based on the confidence level of the position provided in the new inventory data. Errors (together with the two modified data records) are then reported (e.g., by setting an error flag to 1) at step 714, and the Error Detection Module proceeds to steps 608 through 612.

Referring back to FIG. 7, if, at step 704, it is determined that a container pickup event has occurred, the data conflict detection process continues to steps 902 through 920 in FIG. 9, which shows the process to detect errors when a container pickup event occurs. The data conflict detection process first provides a list of error types that corresponds to the container pickup event. In the embodiment shown in FIG. 9, the list of error types includes three error types: no container available for pickup, inaccessible pickup location, and inaccessible operating location. The data conflict detection process then employs a checking process to examine whether an error of one of the three error types has occurred.

At step 902, the data conflict detection process first determines whether there was a container available for pickup at the location specified by the new inventory data. The determination is conducted in three sub-steps: (1) the process determines a search criterion by identifying the pickup location based on the position data (including the height) or the cell location in the new inventory data (this pickup location then constitutes the search criterion); (2) the process then uses the determined search criterion to query the Inventory Tracking Database 114 for inventory data records corresponding to the determined pickup location; and (3) the process determines that no container is available if the query returns no result or results that indicate the location is unoccupied; otherwise, the process determines that the container is available.

If no container is available for pickup at the specified pickup location as determined in step 902, the process can proceed directly to step 908 to report the error with the error type and then proceed to the next error checking step at step 916 to determine whether the HE is operating at an inaccessible location. In another embodiment, the process continues to steps 904 and 906 to identify and modify the erroneous data records. At step 904, the data conflict detection process identifies unoccupied cell location(s) beneath the pickup location by further query of the Inventory Tracking Database 114 for inventory data records corresponding to the cell location(s) beneath the pickup location.

For the new data to be correct, the cell location corresponding to the new data as well as the cell location(s) beneath it must have been occupied before the pickup event. The absence of these containers indicates an error either in the Inventory Tracking Database 114 or in the new data.

Next in step 906, to enhance the integrity of the Inventory Tracking Database 114, the data conflict detection process then creates inventory data records to reflect the occupancy of those cell locations determined in step 904. The data conflict detection process further marks these containers, e.g., as “Invisible Containers,” to distinguish them from “normal” containers where no errors have been found. Also at step 906, the data conflict detection process further calculates the confidence level (i.e., the “Invisible Container Confidence Level”) for these “invisible” containers. The calculation of the confidence level follows similar formulas as those used in step 712 and is based on the confidence level provided in the new inventory data. In addition, the data conflict detection process also marks the new data as erroneous since it can be wrong as well. In one embodiment, this involves adding an error flag to the new data to indicate the error as well as the error type.

The data conflict detection process then proceeds to step 908 to report the error, as well as the type of error, the unoccupied cell locations, and the newly created inventory data records for the “invisible container(s)”. Subsequently, the process proceeds to the next error checking step at step 916 to determine whether the HE is operating at an inaccessible location.

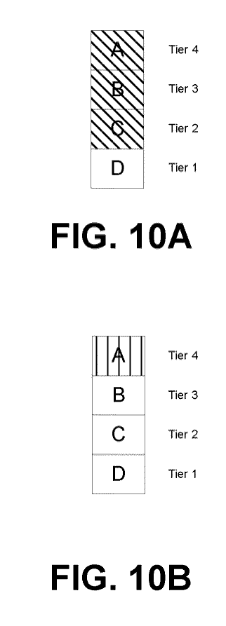

FIG. 10A illustrates an example where a container was not available for pickup as might be detected in steps 902-908. In this example, the Inventory Tracking Database indicates that there is only Container D at Tier 1 of a specific location while the new inventory data reports that Container A has been picked up at Tier 4 of the specific location. Correspondingly, after the Error Detection Module 302 reads the new inventory data at steps 604, the Error Detection Module enters the data conflict detection process at step 606 as shown in FIG. 7. Going through steps 702 and 704, the Error Detection Module determines that a container pickup event has occurred, and then checks whether the container was available for pickup at step 902. As only Container D exists in the Inventory Tracking Database, the query on Tier 4 of the location returns no result, which leads to the conclusion that no container was available for pickup. At step 904, the Error Detection Module 302 then queries on Tier 1 through Tier 3 of the location, and the result will include only one inventory data record showing that Container D is at Tier 1 of the location. Thus, according to the Inventory Tracking Database, Tiers 2, 3, and 4 of the location are empty; however, according to the new data, Tiers 2, 3, and 4 of the location should have been occupied. Accordingly, at step 906, the Error Detection Module 302 creates three inventory data records, with cell locations at Tier 2, 3, and 4 respectively, and the “Type of Container” of these records is marked, e.g., as “Invisible Container.” Since the container at Tier 4 has been picked up according to the new data, the Error Detection Module 302 further marks the newly created data records corresponding to this pickup location, e.g., as “expired,” to indicate it is only valid in the past. Alternatively, the Error Detection Module 302 can just create inventory data records for the cell locations at Tiers 2 and 3. In addition, the new data is also marked due to the data conflict, since it can potentially be incorrect as well. In one embodiment, the new data is marked by adding an error flag for the error detected.

The Error Detection Module 302 may further assign the confidence level of the pickup event given in the new inventory data or a function of this confidence level to be the confidence level of the newly created inventory data records. Subsequently, the data conflict detection process reports the errors as well as the newly created data records at step 908 and then proceeds to the next error checking step to determine whether the HE is operating at an inaccessible location at step 916.

Referring back to FIG. 9 and proceeding to step 910, if it is determined that a container was available for pickup in step 902, the data conflict detection process then goes to the next error checking step to determine whether an error of the type, inaccessible pickup location has occurred at step 910. That is, the data conflict detect process determines if the container was picked up at an inaccessible location at step 910. An example is shown in FIG. 10B, where the new inventory data indicates that Container B has been picked up from Tier 3 but the Inventory Tracking Database shows that Container A is stacked above Container B at Tier 4. Due to the existence of Container A on top of Container B in the Inventory Tracking Database, Container B should actually have been inaccessible unless Container A had been picked up first. To determine whether the container picked up was at an inaccessible location, the data conflict detection process first determines a search criterion by checking if the pickup location is at the top tier, i.e., Tier 4 in this exemplary storage facility. If yes, the pickup location is deemed accessible and no search criterion and no query are needed; therefore, the process continues to step 916. Otherwise, the cell locations above the pickup location constitute the search criterion and the data conflict detection process further uses this search criterion to query the Inventory Tracking Database 114 for inventory data records that are associated with the cell locations above the pickup location. If the query returns no results or results indicating that no containers are above the pickup location, the data conflict detection process concludes that the pickup location is accessible and proceeds to the next error checking step at step 916. For the example shown in FIG. 10B, the query is on Tier 4 of the specific location since the pickup location is at Tier 3. In this example, the query will return an inventory data record showing Container A is at Tier 4; therefore, the data conflict detection process determines that the pickup location should not have been accessible at step 910 and concludes that an error of the type, inaccessible pickup location, has occurred. The process can then proceed to report the error together with the type of the error at step 915. Alternatively, the process can further identify and modify the erroneous data records at steps 912 and 914 before going to step 908.

Processing in one embodiment can proceed from step 910 to report the data in step 915. In an alternative embodiment at step 912, the process reads the data records resulted from the query for further processing and proceeds to step 914 where the data conflict detection process then marks those containers, e.g., as “Ghost Container,” in a field representing the type or property of the container in the inventory data record to indicate that they only exist in the Inventory Tracking Database. Furthermore, a confidence level, named the “Ghost Container Confidence Level,” is also calculated at step 914 based on the confidence level provided in the new inventory data; this confidence level is then added to these inventory data records or replace the original confidence level in these inventory data records. The data conflict detection process also marks the new data to reflect the error; in one embodiment, this involves adding an error flag to the new data to indicate the error as well as the error type. Subsequently, the data conflict detection process reports the error in step 908 including the type of the error, and outputs the updated inventory data records.

Next, the data conflict detection process proceeds to step 916 to determine if the HE itself is operating at an inaccessible location. This step 916 occurs after the process steps (steps 902 through 908 and steps 910 through 914) associated with the previous two error types (i.e., no container available for pickup and inaccessible pickup location), since this third error type in step 916 is not mutually exclusive with the other two error types.

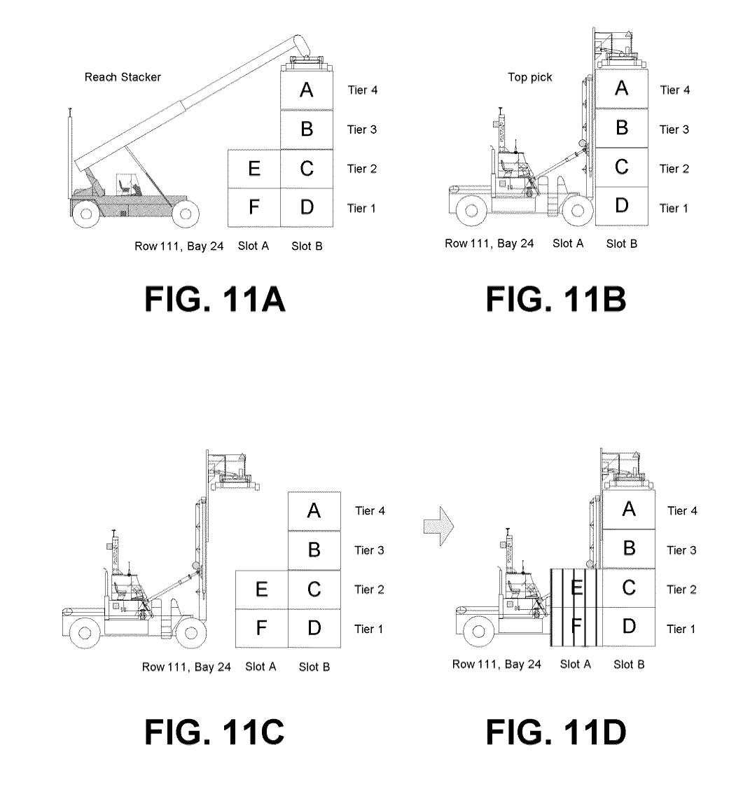

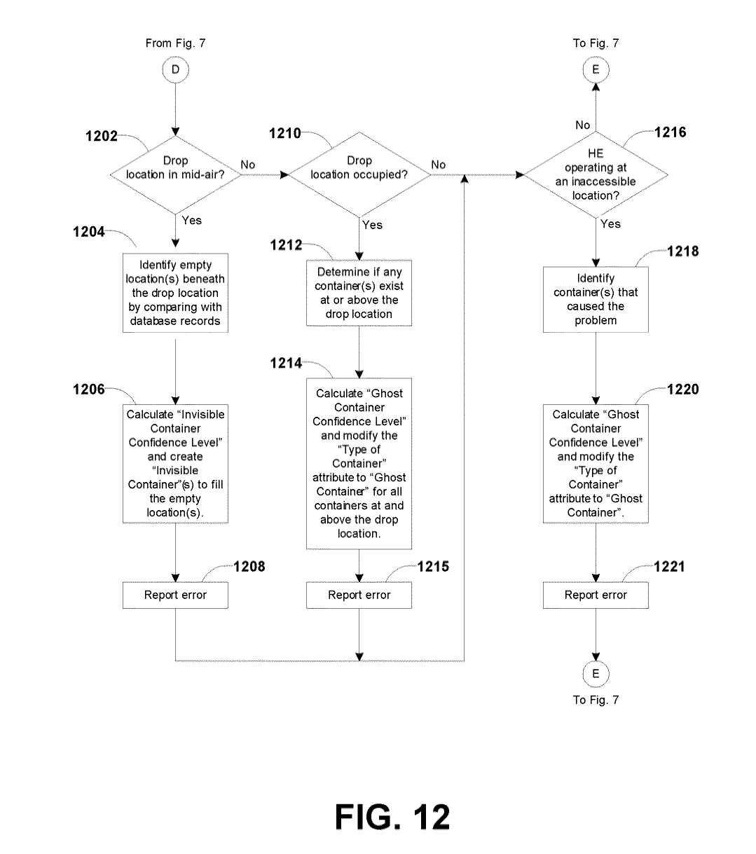

FIGS. 11A-11D show circumstances illustrating why HE can be in an inaccessible location, requiring steps 916-920. FIGS. 11A and 11B show two examples of HE operating at accessible locations, where the HEs can legitimately pick up Container A. However, FIGS. 11C and 11D show that due to the existence of Containers E and F, the HE, a top pick, does not have the access to Container A even though Container A can be accessed by a reach stacker (a different type of HE) as shown in FIG. 11A.

In one embodiment, in order to identify whether an HE is operating at an inaccessible location, a clearance area is defined for each type of HE. Such a clearance area can be represented by a rectangular area, a circular area, or an area with other shapes (depending on the shape of the HE) in an HE controller access area memory, with the location of the container being picked up as the reference point. Alternatively, the clearance area can be represented directly by cell locations with reference to the location of the container being picked up. The cell locations within this clearance area constitute the search criterion and the data conflict detection process uses this search criterion to query the Inventory Tracking Database 114 for inventory data corresponding to the locations in the clearance area. If the query yields no records or records that indicate no container in the clearance area, the HE is not operating at an inaccessible location as determined in step 916, and the data conflict detection process exits to step 608 without further reporting errors. However, if the query in step 916 yields results showing that there are containers at the cell locations in the clearance area, the data conflict detection process concludes that the HE is operating at an inaccessible location and proceeds to step 918 to read and receive those records for further processing; namely in step 918, any containers causing the inaccessibility problem are identified. Alternatively to proceeding with step 918, the data conflict detection process can bypass steps 918 and 920 and directly proceed to step 921 to report the error with the error type.

At step 920, the data conflict detection process then marks the containers, identified in step 918, e.g., as “Ghost Container,” in a field representing the type or property of the container in these inventory data records to indicate that they only exist in the Inventory Tracking Database. Furthermore, a confidence level, named the “Ghost Container Confidence Level,” is also calculated at step 920 based on the confidence level provided in the new inventory data; this confidence level is then added to these inventory data records or replaces the original confidence level in these inventory data records. Subsequently, the data conflict detection process reports the error in step 921 including the type of the error, outputs the updated inventory data records, and exits to steps 608 through 612.

Referring back to FIG. 7, if a container drop event has been detected through steps 702 through 706, the process continues to steps 1202 through 1220 in FIG. 12. In this embodiment, the set of error types corresponding to a container drop event includes drop location in mid-air, occupied drop location, and inaccessible operating location. The data conflict detection process then employs a checking process to examine whether a data error of any of the three error types has occurred. The first error checking step starts with step 1202, where the process determines if the drop location was in mid-air. This error type refers to the case in which a container was dropped or placed at a cell location where the Inventory Tracking Database did not reflect a container to exist immediately underneath it, providing the necessary physical support. Based on this error type, the data conflict process first determines a search criterion that includes cell locations under the drop location specified in the new data. If the drop location is at Tier 1, i.e., the base tier that rests immediately on the ground, there is no cell location beneath the drop location and the data conflict detection process directly concludes that the drop location is not in mid-air and proceeds to step 1210 for the next error checking step. Otherwise, the search criterion includes all cell locations beneath the drop location and the data conflict detection process uses this search criterion to query the Inventory Tracking Database 114 for any inventory data records associated with these cell locations. If the query returns no results for any of the cell locations beneath the drop location, or results indicating that the Inventory Tracking Database 114 does not contain any data record showing a container at the specified location beneath the drop location, the data conflict detection process then concludes that the drop location is indeed in mid-air and an error has occurred. In one embodiment, the data conflict detection process can bypass steps 1204 and 1206 and proceed to step 1208 to report the error together with the error type (i.e., drop location in mid-air). Alternatively, the process proceeds to steps 1204 and 1206 before reporting the error at step 1208.

At step 1204, the data conflict detection process identifies the unoccupied cell location(s) beneath the drop location based on the query results. More particularly, step 1204 identifies empty cell locations beneath the drop location by comparing the HE designated drop location with database records. With the assumption that the new inventory data is accurate and therefore there must be containers underneath the drop location in reality, the data conflict detection process at step 1206, creates a new inventory data record for each of the unoccupied cell locations beneath the drop location, and assigns a container to each of them. Since these containers were invisible to the Inventory Tracking Database before, they are marked, e.g., as “invisible container,” in the “Type of Container” field in their respective data records. Furthermore, a confidence level, named the “Invisible Container Confidence Level,” is also calculated at step 1206 based on the confidence level provided in the new inventory data; this confidence level is then included in each of the newly created data records. The data conflict detection process then reports the error with the error type and outputs the newly created data records including the newly calculated confidence level(s) at step 1208. Subsequently, the data conflict detection process proceeds to the next checking step to determine whether the HE is operating at an inaccessible location at step 1216.

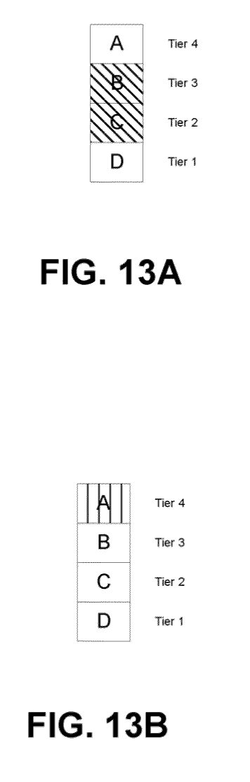

FIG. 13A illustrates an example where the drop location is in mid-air. As shown on the left, the Inventory Tracking Database indicates that Container D is at Tier 1 and no container is located above Container D. The new inventory data indicates Container A has been dropped at Tier 4. The data conflict detection process then identifies that there are three cell locations (Tier 1, Tier 2, and Tier 3) beneath the drop location at Tier 4; it then queries the Inventory Tracking Database for those three cell locations. The query returns only one data record showing Container D at Tier 1; thus no data records for Tier 2 and Tier 3 appear in the query results. Therefore, the data conflict detection process concludes that the drop location is in mid-air at step 1202 and identifies that the two cell locations at Tier 2 and Tier 3 need further processing at step 1204. Accordingly, at step 1206, the data conflict detection process creates two new data records, one for Tier 2 and the other for Tier 3, assigns two containers with their “Type of Container” attribute set to “invisible container” for the two newly created data records, and further computes and includes the confidence level in the two data records. The data conflict detection process then reports the error, outputs the two newly created data records including the newly calculated confidence level(s), and exits to step 1216 to examine whether the HE is operating at an inaccessible location.

Referring back to step 1202 of FIG. 12, if the drop location was not in mid-air, the process continues to step 1210 for the next error checking step to determine whether an error of the error type, occupied drop location, has occurred. At step 1210, the data conflict detection process determines if the drop location was already occupied by another container in the Inventory Tracking Database 114. To make that determination, the data conflict detection process first determines a search criterion based on the drop location in the new data; this search criterion includes the drop location and the cell location(s) above the drop location if the drop location is not at the top tier. The data conflict detection process then uses this search criterion to query the Inventory Tracking Database for inventory data records associated with these cell locations specified in the search criterion. If the query yields no results or results indicating no container at the drop location or the locations above the drop location, the data conflict detection process concludes that the drop location was not occupied and proceeds to the next error checking step at step 1216. Otherwise, the data conflict detection process concludes that the drop location was already occupied and therefore an error of this error type has occurred. In one embodiment, the data conflict detection process can directly bypass steps 1212 and 1214 and proceed to step 1215 to report the error with the error type; in another embodiment, the process continues to steps 1212 and 1214 before proceeding to report the error at step 1215.

At step 1212, the data conflict detection process reads or retrieves the data records in the query result for further processing. For the new inventory data that indicates the drop event to be correct, therefore the data records in the query results must be erroneous, and vice versa. That is, both the new inventory data and the data records in the query results could be wrong; hence, both of them are treated as erroneous data records. The data conflict detection process then in step 1214 modifies the “Type of Container” attribute to “Ghost Container” in each of the data records derived from the query results. The data conflict detection process further computes a new confidence level for each of the data records based on the confidence level of the drop event; this new confidence level is then added to the corresponding data records or replaces the confidence level originally in the data records. The data conflict detection process can also mark the new data to reflect the error and add an error flag to the new data. Subsequently, the data conflict process reports the error at step 1215, outputs the modified data records with the newly calculated confidence levels, and proceeds to the next error checking step at 1216.

FIG. 13B illustrates an example where the drop location is already occupied. As shown on the left, the Inventory Tracking Database shows that there are four containers stacked together, occupying all four tiers of a specific location. A new inventory data indicates that a drop event has occurred, in which another container is placed at Tier 4 of the specific location. Accordingly, at step 1202, the data conflict detection process determines that the drop location is not in mid-air since the cell locations beneath Tier 4 are all occupied. The data conflict detection process then queries the Inventory Tracking Database for data records at the drop location (i.e., Tier 4 of the specific location) at step 1210, and the query yields a data record showing Container A already at the drop location (before the drop event). Hence, the data conflict detection process concludes that the drop location was occupied and proceeds to steps 1212 and 1214 to mark Container A as “Ghost Container” and to update its confidence level. After that, the data conflict detection process reports the error, outputs the modified data record with its newly calculated confidence level, and proceeds to the next error checking step at step 1216 to determine whether the HE is operating in an inaccessible location.

Referring back to FIG. 12, if the drop location was determined to be unoccupied at step 1210 or an error occurred at step 1208 or 1215, the data conflict detection process proceeds to step 1216 to determine if the HE is operating at an inaccessible location. The determination and the subsequent steps 1218 to 1221 are similar to the processing involved in steps 916 to 921; therefore, they are not repeated here.

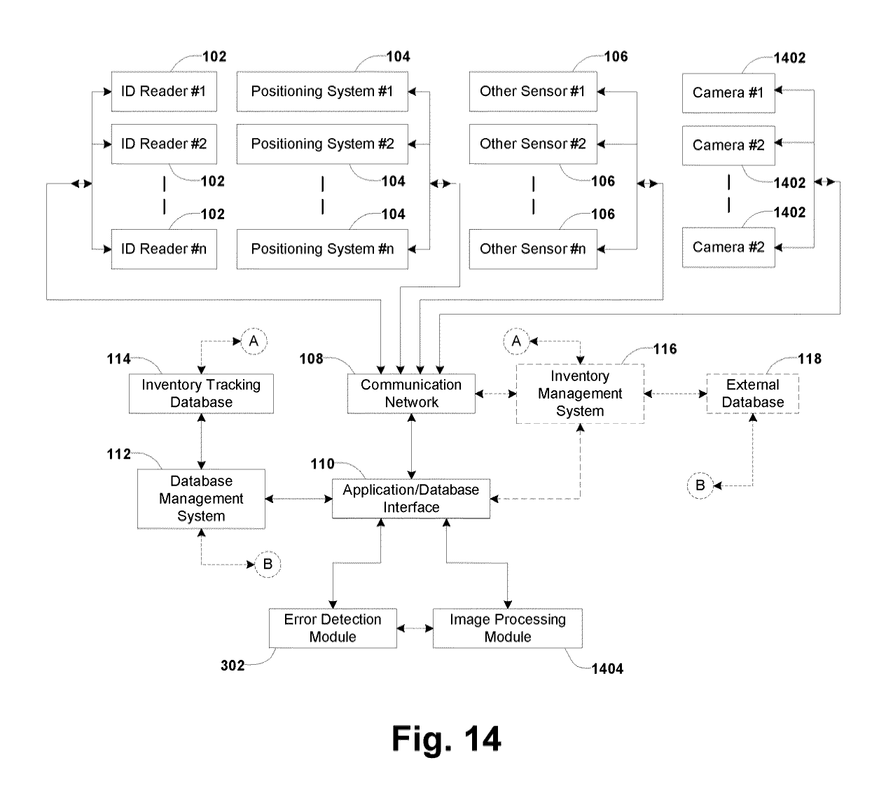

FIG. 14 shows an inventory tracking and management system with camera-based error detection for detecting inventory errors, particularly errors in locations of containers in a container shipping yard. In addition to the components shown in FIG. 3, this system further includes cameras 1402 and an Image Processing Module 1404. The cameras 1402 can be single-lens cameras, stereo cameras with two or more lenses, or sets of single-lens cameras with each set configured to serve as a stereo camera. The cameras 1402 can be installed at fixed locations (e.g., selected light poles) in the container shipping yard. Each camera (or each set of cameras) can be positioned toward a designated area of the yard, and it can also rotate within a pre-set range in order to cover a larger area than it would with a fixed angle. When distributed over the container shipping yard properly, these cameras 1402 can scan the whole yard and provide images to the Application/Database Interface 110 through the Communication Network 108. The Application/Database Interface 110 outputs the images to the Image Processing Module 1404, which processes the images to determine whether a cell location is occupied and generates inventory-validation data accordingly. The generated inventory-validation data is then sent to the Error Detection Module 302, which compares the inventory-validation data with data records in the Inventory Tracking Database 114 for error detection. The Application/Database Interface 110 may also display the images on a display for an operator to monitor operations and activities in the yard.

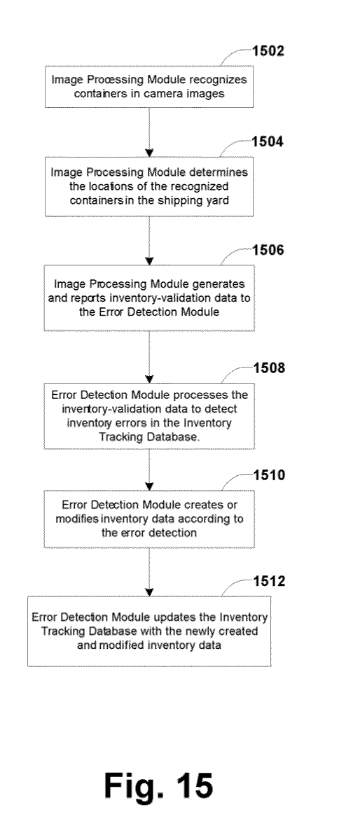

FIG. 15 is a flowchart showing the process of detecting inventory errors based on images from the cameras 1402. The process can be set to run at a specific time every day; it can also be initiated by an operator at any time or even run in real time. Starting at step 1502, the Image Processing Module 1404 receives camera images from the Application/Database Interface 110 and processes the images for container recognition. Various image processing techniques and pattern recognition techniques can be employed to recognize containers, e.g., by treating containers as cubes or cylinders (e.g., for tank containers) with specific dimensions; these techniques are well-known to those skilled in the art. By using such techniques, the Image Processing Module 1404 recognizes containers in an image as well as their (relative) positions (including height above ground) in the image, where each position is the position of the center of a container. The Image Processing Module 1404 may further identify attributes of the recognized containers; such attributes include the containers' colors, types, origins, manufacturers, and even container IDs.

Once containers are recognized together with their (relative) positions in the image, the Image Processing Module 1404 further determines the locations of the containers in the container shipping yard at step 1504. In one embodiment, the Image Processing Module 1404 determines the location of a container based on the location of the camera that provides the image, the camera's scanning angle at the time the image was taken, and the relative position of the container in the image. More specifically, since each camera is at a fixed location, its field of view (i.e., the area captured in the image) can be determined based on the camera location and scanning angle. As a result, a location profile that associates a field of view with the container shipping yard can be pre-determined for each camera at any specific scanning angle. Such a location profile can be represented by a two-column conversion table, with one column containing the cell locations (e.g., Row 101, Bay 21, Slot A, Tier 1) in the shipping yard and the other column containing the corresponding positions (e.g., px, py, and pz) in the image. Moreover, multiple location profiles can be built for a camera by selecting multiple (equally-spaced) scanning angles within the scanning range of the camera. The spacing of these scanning angles should be relatively small so that images taken at any scanning angle can be mapped correctly into the container shipping yard by using the location profile corresponding to the closest pre-selected scanning angle. Before mapping an image taken at any scanning angle, the Image Processing Module 1404 may rotate it so that the rotated image approximates an image taken at the closest pre-selected scanning angle. Subsequently, the Image Processing Module 1404 determines the locations of containers in the container shipping yard based on the location profiles.

In another embodiment, the Image Processing Module 1404 identifies landmarks in the image to determine the corresponding location in the container shipping yard for each recognized container. The landmarks can include line markers on the ground, nearby light poles, and other fixtures such as buildings in the field of view. Since the locations of these landmarks in the container shipping yard can be pre-determined, these landmarks can be used as reference points for determining the locations of the recognized containers in the shipping yard.

So far at both steps 1502 and 1504, the Image Processing Module has recognized containers in each image and determined their locations in the shipping yard. The Image Processing Module 1404 can further compare and correlate the container recognition results from multiple images taken by one camera, as well as the recognition results from images taken by multiple cameras, to further evaluate the consistency of the recognition result so as to achieve higher accuracy in the container recognition.

Subsequently at step 1506, the Image Processing Module 1404 generates inventory-validation data based on the container recognition and the locations of the recognized containers. For example, since each camera scans or covers a pre-determined designated area, the Image Processing Module 1404 can have a pre-determined template for the inventory-validation data for each camera. The template can be as simple as a two-column table, with one column listing all the cell locations in the designated area and the other column for indicating whether a container is detected at the corresponding cell location. The Image Processing Module 1404 fills in the second column based on the container recognition at step 1502 and the location determination at step 1504. The table may be expanded to include columns for other information such as the attributes of each recognized container and a time stamp for each row entry of the table; such a time stamp can be the time the corresponding image was taken. The Image Processing Module 1404 then reports these tables as the inventory-validation data to the Error Detection Module 302 at step 1506. Optionally, the Image Processing Module 1404 can combine the table for each camera into a single table and report the single table to the Error Detection Module 302.

At step 1508, the Error Detection Module 1404 processes the inventory-validation data from the Image Processing Module 1404 to detect inventory errors in the Inventory Tracking Database 114. The Error Detection Module 302 first queries the Inventory Tracking Database 114 for data records corresponding to the cell locations in the inventory-validation data, and then compares the query results with the inventory-validation data for any discrepancy between the two. If a cell location is occupied according to the inventory-validation data but the query results indicate that no container is at that cell location, the container at the location is regarded as a missing container or a container invisible to the Inventory Tracking Database 114. Similarly, if a cell location is not occupied according to the inventory-validation data while the query results indicate that there is a container there, the container is regarded as existing only in the Inventory Tracking Database 114 or a “ghost” container in the Database. Moreover, the Error Detection Module 302 can further compare the container attributes in the inventory-validation data with container attributes in the query results for error detection. For example, if according to the inventory-validation data the Image Processing Module 1404 recognized a 20-foot container at a cell location but the query results show that the container at the cell location is a 40-foot container; the Error Detection Module 302 then detects a discrepancy in attributes at the cell location. All three cases of discrepancies indicate errors in the Inventory Tracking Database 114.

At step 1510, the Error Detection Module 302 further creates or modifies inventory data according to the error detection. More specifically, the Error Detection Module 302 creates an inventory data record for each cell location where a missing container is identified; the Error Detection Module 302 also marks the container attribute (e.g., the “Type of Container” field) in this newly created data record (e.g., as “Invisible Container”) to indicate that the container was invisible to the Inventory Tracking Database 114. For cell locations where “ghost” containers are identified, the Error Detection Module 302 modifies the corresponding data record in the query result to reflect the error, e.g., by marking the container property as “Ghost Container.” For cell locations with mismatched attributes, the Error Detection Module 302 can modify the corresponding data records in the query result to add the attributes in the inventory-validation data (which are the attributes recognized by the Image Processing Module). The Error Detection Module 302 can further add a confidence level to the data record using a pre-determined confidence level associated with the Image Processing Module 1404.

Subsequently at step 1512, the Error Detection Module 302 reports the newly created data records and the modified data records to the Inventory Tracking Database 114 for an update.

In a separate embodiment, cameras installed on HEs or monitoring vehicles can be used either alone or in conjunction with the cameras installed at fixed locations. Since these cameras are mobile, the Image Processing Module 1404 determines the locations of the recognized containers by recognizing landmarks and using landmark locations as references. Alternatively, the Image Processing Module 1404 can use positions of the vehicle that carries the camera for determining the locations of containers. Subsequently, the Error Detection Module 302 detects errors and creates or modifies inventory data as described with FIG. 15.

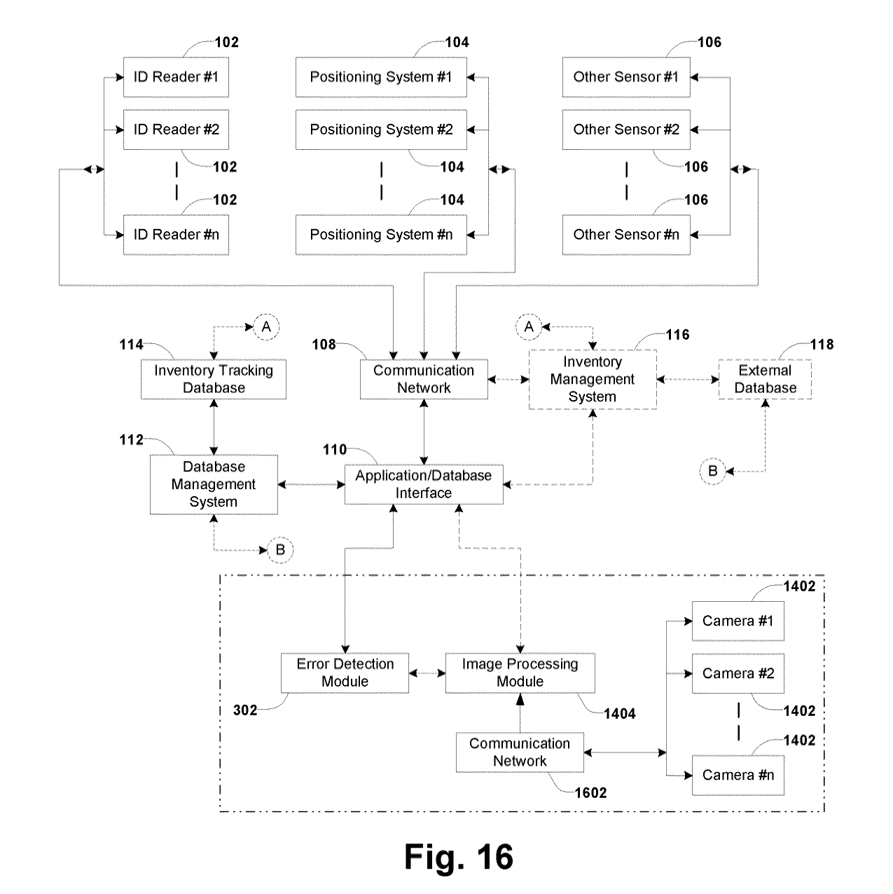

FIG. 16 shows an embodiment of a camera-based inventory error detection system interfacing with an inventory tracking system for detecting errors in an inventory tracking database associated with the inventory tracking system. The camera-based inventory error detection system includes the cameras 1402, a separate wired and/or wireless communication network 1602, the image processing module 1404, and the error detection module 302. The communication network 1602 directly connects the cameras 1402 with the image processing module 1404 for transmitting images generated by the cameras to the image processing module 1404; therefore, the image processing module 1404 does not need to receive the images through the Application/Database Interface 110 as shown in FIG. 14. Hence, the camera-based inventory error detection system becomes an independent system interfacing with the inventory tracking system, which may be preferred in some applications. The processing involved in the image processing module 1404 and the error detection module 302 is similar to the process shown in FIG. 15, which was described before together with the inventory tracking and error detection system in FIG. 14.

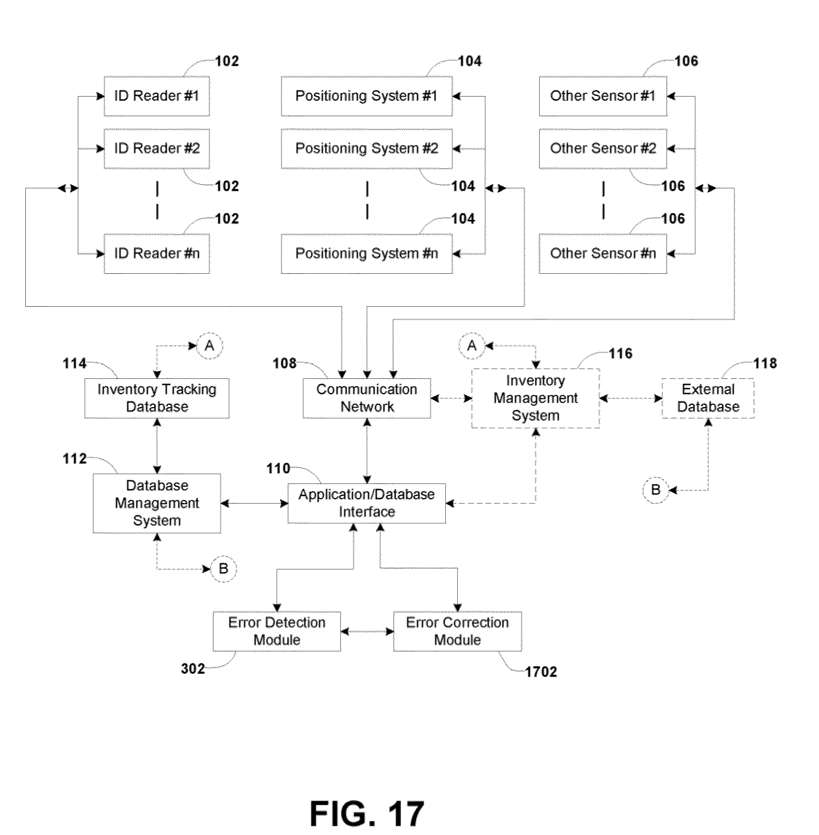

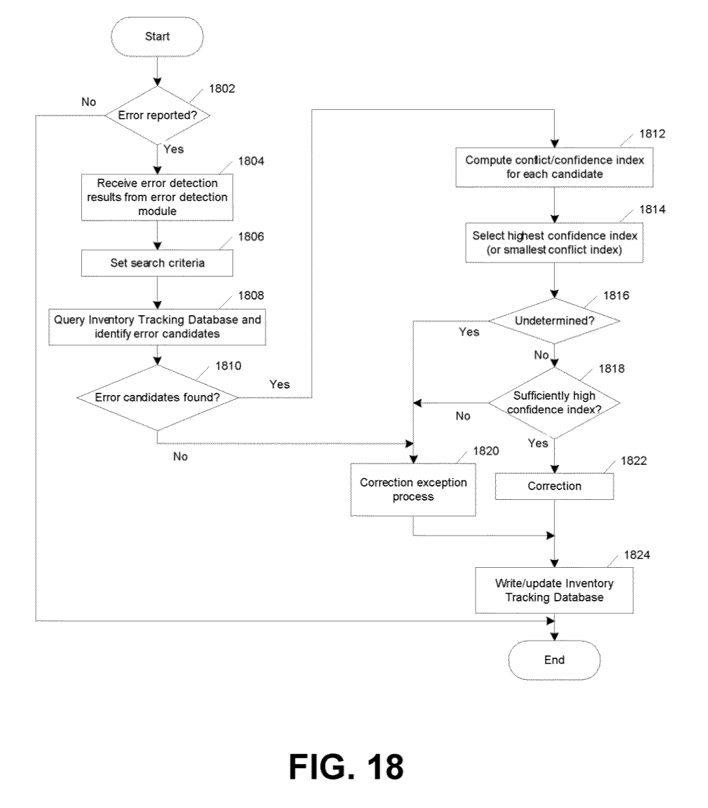

FIG. 17 shows a block diagram of an inventory tracking and management system with automatic inventory error detection and inventory error correction components included according to embodiments of the present invention. In addition to the components in a typical inventory tracking and management system as shown in FIG. 1 and the Error Detection Module 302 that examines the validity of inventory data and automatically detects errors in the Inventory Tracking Database 114, the system further includes an Error Correction Module 1702 that receives the error detection results from the Error Detection Module 302 and corrects the detected errors. Details of the Error Correction Module 1702 will be described later with respect to FIG. 18 to FIG. 23. Although manual intervention is not necessary in the error correction process, the Error Correction Module 1702 can allow operators to manually intervene in the error correction process if the operators so desire.

FIG. 18 is a flowchart showing one embodiment of the error correction process executed by the Error Correction Module 1702. Initially in FIG. 18, the error correction process checks whether a new error has been reported from the Error Detection Module 302 in step 1802. As described earlier with FIG. 6, the Error Detection Module 302 checks data conflict and detects errors in step 606 and the outputs of step 606 include at least one variable (e.g., error_detected_flag) indicating whether or not data conflicts/errors have been detected. For example, the process in step 606 sets a Boolean variable, e.g., error_detected_flag, to 1 if an error has been detected or to 0 if no error has been detected. In step 610, the Error Detection Module reports the error by outputting this variable together with any newly created data records for “invisible” containers, any corrected data records for “ghost” containers, as well as the new data received in step 602 (which is the cause of the error if any error has been detected). Therefore, by examining the value of the variable (e.g., error_detected_flag) that indicates the detection of errors, the error correction process can determine whether any error has been reported by the Error Detection Module 302.

If there is no new error(s) reported, the error correction process ends and waits for the next processing cycle to restart in step 1802 to check again whether a new error(s) has been reported. If there is an error reported (i.e., the Error Detection Module detects an error), the error correction process continues to step 1804 to read the corresponding error detection results from the Error Detection Module 302. As described earlier in step 610, the relevant error detection results include newly created data records for “invisible” containers, data records for “ghost” containers, as well as the new data received in step 602.

Subsequently in step 1806, the error correction process determines search criteria which will be used in the search for error candidates in step 1808. Typically the errors are created due to inaccuracies in the estimation of container positions (sometimes by estimating the position of the handling equipment); therefore, the search criteria typically involve container cell locations surrounding the container cell locations associated with the error detection results. For example, if the error detection results from the Error Detection Module 302 include a container invisible to the Inventory Tracking Database 114 at container cell location (Row 111, Bay 24, Slot B, Tier 4), the search criteria can include the directly-adjacent container cell locations: (Row 111, Bay 24, Slot A, Tier 4), (Row 111, Bay 24, Slot C, Tier 4), (Row 111, Bay 23, Slot B, Tier 4), (Row 111, Bay 23, Slot B, Tier 4), (Row 111, Bay 25, Slot B, Tier 4), and (Row 111, Bay 24, Slot B, Tier 3). Depending on the accuracy of the positioning system, the search criteria may expand to container cell locations that are further away, such as (Row 111, Bay 22, Slot B, Tier 4). If additional height sensors are used to provide high-accuracy height measurements, the search criteria may only involve container cell locations that are on the same tier as the cell locations in the error detection results.

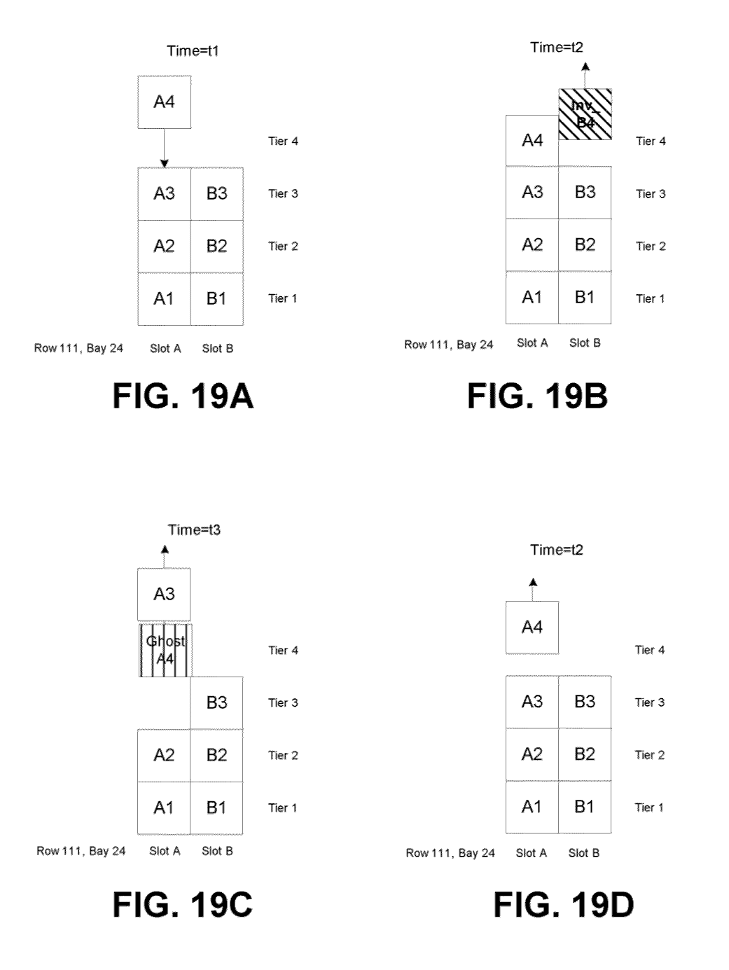

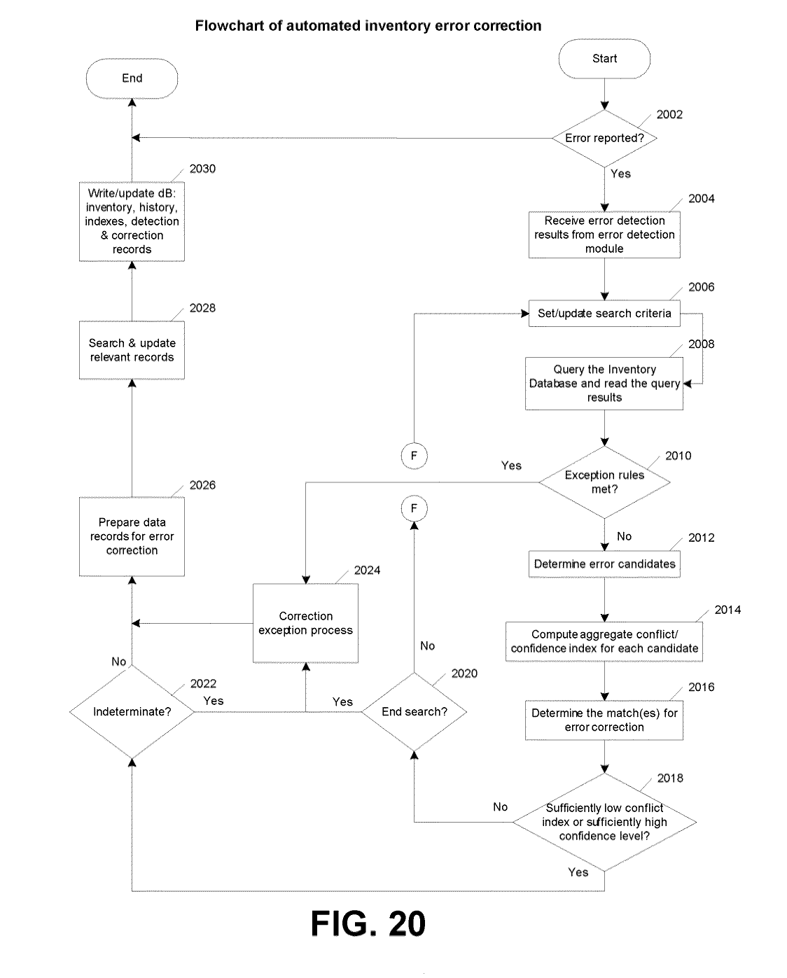

In step 1808, the error correction process queries the Inventory Tracking Database 114 using the search criteria determined in step 1806 and then determines error candidates from the query results. In one embodiment, the error candidates include only previously-detected errors or erroneous data records, and the purpose of step 1808 is to find whether there are any “invisible” or “ghost” containers at the container cell locations specified in the search criteria (e.g., by examining the container attributes [e.g, “Type of Container” field] in the query results). If the Error Detection Module 302 creates tables in the Inventory Tracking Database 114 and records the erroneous data records in the tables upon the detection of data errors (e.g., in step 612 of FIG. 6), the query can be conducted on these tables to find whether there are (previously detected) erroneous data records at those container cell locations specified in the search criteria. An example of this embodiment will be described later with FIG. 19. In another embodiment, the error candidates also include regular data records and an example will be described together with FIG. 20 to FIG. 23.

Subsequently in step 1810, the error correction process examines whether the query yields any error candidates. If no error candidates are found, the error correction process continues to step 1820 to execute a correction exception process. In this case, the correction exception process sets an exception flag to a value indicating that the exception is due to no error candidates. In step 1824, this exception flag can then be added to the data records corresponding to the detected error. Alternatively, an error correction log file can be created to record the detected error and the exception flag. The Inventory Tracking Database 114 will then be updated accordingly. In some other embodiments, if it is determined that no error candidates are found in step 1810, the error correction process may go back to step 1806 to expand the search criteria, e.g., by including container cell locations further away from the container cell locations corresponding to the detected error, and to conduct another search in step 1808. The error correction process may iterate between steps 1806 to 1810 until (a) error candidates are found or (b) a pre-determined condition has been met (e.g., a threshold for the search range has been reached). In the former case, the error correction process continues to step 1812 and in the latter case, the error correction process then continues to step 1820 to execute the correction exception process as described earlier.

If the query results in one or more error candidates, the error correction process then continues from step 1810 to step 1812 to evaluate each error candidate and its possibility of being the match that can be used to correct the currently-detected error. The evaluation can involve computing a confidence/conflict index for each candidate. For each erroneous data record in the error detection results, the error correction process computes the confidence index of the error candidates that correspond to the data record based on the confidence level of the data record itself, the confidence level of the error candidate, the distance from the position of the data record to the container cell location of the error candidate, and the distance from the position of the error candidate to the container cell location of the data record. In one embodiment, the confidence index is calculated as k×Conf_{error candidate}×Conf_{data record}, where Conf_{error candidate} and Conf_{data record} is the confidence level of the error candidate and the data record respectively (in the error detection results), and k is a weighting factor based on the two distances mentioned above. For example, k=L/(l1×l2), where l1 is the distance from the position of the data record to the center of the container cell location of the error candidate, l2 is the distance from the position of the error candidate to the center of the container cell location of the data record, and L is a pre-determined number for normalization purposes. For example, L can be defined as the square of one container width. Thus, the shorter those two distances are, the higher the weighting factor k is and the higher the confidence index is.

Subsequently in step 1814, for each data record in the error detection results, the computed confidence indexes of its corresponding error candidates are sorted and the error candidate(s) corresponding to the highest confidence index (or the smallest conflict index) is selected as a potential match for that data record. If for any of the data records in the error detection results, the number of error candidates that yield the highest confidence index is more than one, multiple potential matches are found for one data record and the error correction process cannot make a decision which one of these potential matches could be the match for error correction. In this case, the error correction process regards the match as undetermined in step 1816 and proceeds to the correction exception process in step 1820. Accordingly, the correction exception process sets the exception flag to a value indicating that multiple potential matches have been found. The error correction process then proceeds to step 1824 to update the erroneous data records with the exception flag and to update the error correction log.

Referring back to step 1816, if only one potential match is found for each of the data records in the error detection results, the error correction process continues to step 1818 to determine whether the corresponding highest confidence index for each data record is high enough, typically by comparing it with a pre-determined threshold. If for any of the data records in the error detection results, the highest confidence index is still not high enough (i.e., larger than the pre-determined threshold), the error correction process goes to step 1820 to set the exception flag to a value indicating that the potential match does not provide a sufficiently high confidence index. The error correction process then proceeds to step 1824 to update the erroneous data records with the exception flag and to update the error correction log. Alternatively, the error correction process may go back to step 1806 to expand the search criteria and start an iteration from step 1806 to step 1818 instead of going directly to step 1820 for the correction exception process. The error correction process can repeat the iteration until (a) the highest confidence index is high enough or (b) a pre-determined condition is met (e.g., a threshold for the search range has been reached). In the former case, the error correction process continues to step 1822 and in the latter case, the error correction process then continues to step 1820 to execute the correction exception process as described earlier.

If the highest confidence indexes for all of the data records in the error detection results are sufficiently high, the potential match for each of the data records is then regarded as the match of the corresponding data record for correcting the currently-detected error. The error correction process then continues to step 1822 to perform the actual correction by merging each of the data records of the currently-detected error with the data record of its corresponding match. In the embodiment mentioned earlier, only data records that are erroneous (i.e., data records that involve “invisible” or “ghost” container) can be error candidates; therefore, each pair (the data record and its match) includes one “invisible” container and one “ghost” container and the correction involves merging an “invisible” container with a “ghost” container. The error correction process creates a duplicate data record by copying the “invisible” container and then changes the container information and the container cell location in the duplicate data record to those of the “ghost” container. The error correction process further modifies the container “type of container” attribute of the duplicate data record to indicate it is a “normal” container instead of a “ghost” container and update the confidence level to be the highest confidence index determined in step 1814. The modified duplicate data record then becomes the corrected data record and the error correction process marks the two data records corresponding to the “invisible” container and the “ghost” container as obsolete or expired.

In step 1824, the error correction process updates the Inventory Tracking Database 114 with the corrected data record; the error correction process also records the successful correction in both the error detection log and the error correction log to reflect that the detected error has been corrected.

FIGS. 19A-19D provide an example to illustrate how one embodiment of the error correction process in FIG. 18 works. FIG. 19A shows a container drop-off operation at time t1. Before time t1, the Inventory Tracking Database has records showing that containers A1, A2, and A3 occupy Tier 1 to Tier 3 of Row 111, Bay 24, Slot A respectively and containers B1, B2, and B3 occupy Tier 1 to Tier 3 of Row 111, Bay 24, Slot B respectively. For description purposes, the labels such as A1 are used to describe both the containers, such as in Container A1, and the container cell locations such as in Location A1. At time t1, the inventory tracking system detects that Container A4 has been dropped off to Location A4 (Row 111, Bay 24, Slot A, Tier 4), right on top of Container A3. If the HE (Handling Equipment) is operating in an accessible location in this example, the error detection process then goes through the corresponding steps shown in FIG. 6, FIG. 7 and FIG. 12 and determines that no error has occurred since the drop-off location (Location A4) is not in mid-air and it was not occupied before the drop off operation. Accordingly, the error correction process determines that no error has been reported in step 1802 and immediately exits to wait for the next processing cycle.

Subsequently at time t2, the Inventory Tracking System detects that the HE picked up a container from Location B4 (Row 111, Bay 24, Slot B, Tier 4) as shown in FIG. 19B. However, the error detection process identifies that there is no container listed in the Inventory Tracking Database 114 that could have been picked up at Location B4 in step 902 of FIG. 9. Since there are containers (B1, B2, and B3) occupying all the container cell locations beneath the pickup location, the error detection process identifies that the pickup location is the empty location in step 904. Accordingly, the error detection process creates a container Inv_B4 at Location B4, assigns the container an attribute (e.g., “invisible” container) to indicate that it was invisible to the Inventory Tracking Database 114 before (e.g., by setting the “Type of Container” field to “invisible container”), and associates the container with the pickup operation in step 906.

Also in step 906, the error detection process determines that a high enough confidence level exists for Container Inv_B4 to be classified as an “invisible” container, that is, the confidence level that Container Inv_B4 is at Location B4 although the Inventory Tracking Database 114 does not have a corresponding data record. As described earlier in [0064], this confidence level, Conf(Inv_B4), is usually calculated as a function of the confidence of the position data in the new inventory data. In a simplest embodiment, the confidence level is set to be the confidence of the position data; alternatively, the calculation can further incorporate the confidence level of the pickup event of Container Inv_B4. In this example, it is assumed that Conf(Inv_B4), the confidence level for Container B4 to be an “invisible” container, is 80% (with the minimum confidence level being 0 and maximum confidence level being 1). The error detection process then reports the error to the Error Correction Module 302 in step 908.

Since an error has been reported, the error correction process continues from step 1802 to step 1804 to receive the error detection results, which in this case include the newly created data record showing that Container Inv_B4 is an “invisible” container and the new data of the pickup operation (which leads to the creation of Container Inv_B4). In step 1806, the search criteria can be determined to include the container cell locations surrounding Location B4, the container cell location associated with the error detection results. In one embodiment, the goal of the search in step 1808 is to find previously-identified erroneous data records (e.g., records with “invisible” containers and “ghost” containers) in the container cell locations specified in the search criteria. To make this example simple, it is assumed that there are no containers in the adjacent slots and bays; that is, only Slot A and Slot B of Bay 24 are occupied in Row 111. Since no erroneous data records have been detected in the surrounding container cell locations, no error candidate(s) will be found and the error correction process continues from step 1810 to step 1820 for the exception process. In step 1820 the exception process marks an exception flag to indicate that no error candidates have been found, and in step 1824 the error detection process adds this exception flag to the data record corresponding to the “invisible” container B4, and/or record the detected error and the exception flag in an error correction log file, and then update the Inventory Tracking Database 114 accordingly.

Subsequently at time t3, the Inventory Tracking System detects that Container A3 at Location A3 has just been picked up. Again, the error detection process compares this pickup operation with the existing data records in the Inventory Tracking Database 114 via steps in FIGS. 6, 7, and 9. In step 910, since the Inventory Tracking Database 114 indicates that Container A4 is occupying Location A4 on top of the pickup location (Location A3), the error detection process determines that the pickup location (Location A3) should have been an inaccessible location without Container A4 being moved first, indicating an error has occurred. Correspondingly in step 912, the error detection process identifies there is only one occupied container cell location (i.e., Location A4) on top of the pickup location (Location A3), and in step 914, the error detection process modifies the data record corresponding to Container A4 (e.g., by changing the value of the “Type of container” field to “Ghost container”) to indicate that Container A4 exists only in the Inventory Tracking Database 114 (i.e., a ghost in the Inventory Tracking Database).

Also in step 914, the error detection process calculates the confidence level that Container A4 is a “ghost” container. In one embodiment, this confidence level, Conf(Ghost_A4), is equivalent to: (1−Conf(A4)), where Conf(A4) is the confidence level that Container A4 is located at Location A4. Conf(A4) was determined at time t1 based on the confidence level of the position data from the positioning system as well as the confidence level of the drop-off operation of Container A4 as shown in FIG. 19A. In another embodiment, the determination of Conf(Ghost_A4) further incorporates the confidence of the pickup operation of Container A3: Conf(Ghost_A4)=f(Conf(A4), Conf_{pickup}(A3)). For example, since the fact that Container A4 is not a “ghost” requires that (1) the drop-off operation of Container A4 at Location A4 must be true and (2) the pickup operation of Container A3 at Location A3 must be wrong, the confidence level, Conf(A4 is NOT ghost), can be calculated as:

Conf(A4 is NOT ghost)=(Conf(A4)×(1−Conf_{pickup}(A3))

Therefore,

Conf(ghost_{—}A4)=1−Conf(A4 is NOT ghost)=1−Conf(A4)×(1−Conf_{pickup}(A3)).

In this example, it is assumed that Conf(Ghost_A4), is 70%. The error detection process then further reports the error to the Error Correction Module in step 915.

Since an error has been reported, the error correction process continues from step 1802 to step 1804 to receive the error detection results, which in this case include the newly created data record showing that container A4 is a “ghost” container at Location A4. In step 1806, the search criteria can be determined to include the container cell locations surrounding Location A4. In one embodiment, the goal of the search in step 1808 is to find previously-identified erroneous data records (e.g., records with “invisible” containers and “ghost” containers) in the container cell locations specified in the search criteria. Since Container Inv_B4 was detected as an “invisible” container at time t2 (which is earlier than time t3), the search will yield one error candidate showing the “invisible” container Inv_B4 at Location B4.

In step 1812, the confidence index for the error candidate (Container Inv_B4) can be calculated as: k×Conf(Inv_B4)×Conf(Ghost_A4), where k is the weighting function described earlier with FIG. 18. This example assumes that k is calculated to be 1.5, therefore, the confidence index is 1.5×80%×70%=84%.

Since only one error candidate is found, its corresponding confidence index computed in step 1812 is treated as the highest confidence index in step 1814. Accordingly, the error correction process proceeds to step 1816 and then to 1818. This example assumes that the highest confidence index is higher than the pre-defined threshold (e.g., 0.6), the error correction process then continues to step 1822 to conduct the correction. In step 1822, the error correction process creates a new modified duplicate data record for the pickup operation of Container Inv_B4 at time t2, by changing the container information and the container cell location in the duplicate data record to that of Container Ghost_A4 and Location A4, respectively. This is illustrated in FIG. 19D which shows at time t2 the pickup operation actually occurred to Container A4 at Location A4 instead of Container Inv_B4 at Location B4. Hence, the modified duplicate data record becomes the correct data record which indicates that the pickup operation at time t2 actually occurred to Container A4 at Location A4. The error correction process then marks both the erroneous data records corresponding to the pickup of Container Inv_B4 and the Container Ghost_A4 as obsolete. In step 1824, the correct data record and the modified data records are updated to the Inventory Tracking Database 114. The correct data record is the new modified duplicate data record showing that Container A4 was picked up at time t2, and the modified data records are the obsolete erroneous data records showing that both Container Ghost_A4 and Container Inv_B4 are obsolete. Thus, the data record corresponding to the drop off of Container A4 at t1 and the data record corresponding to the pickup of Container A3 at t3 remain unchanged; that is, they stay valid without error in the Inventory Tracking Database 114.

FIG. 20 is a flowchart showing another embodiment of the error correction process executed by the Error Correction Module 1702. The embodiment of FIG. 20 builds upon the embodiment described with reference to FIG. 18 where the error candidates include only previously-detected errors or erroneous data records. The embodiment in FIG. 20 extends the error candidates to also include newly collected and regular data records (i.e., data records that do not contain previously-detected errors, as opposed to the erroneous data records of “invisible” or “ghost” containers). In addition, this embodiment also involves a more comprehensive exception process as well.

Initially in FIG. 20, the error correction process checks whether a new error(s) has been reported from the Error Detection Module 302 in step 2002. If there is no new error(s), the error correction process ends and waits for the next process cycle to start with step 2002 again. If a new error(s) has been reported by the Error Detection Module 302, the error correction process reads the error detection results from the Error Detection Module 302. As described earlier in step 610, the error detection results include newly created data records for “invisible” containers, modified data records for ghost containers, as well as the new data received in step 602 (which leads to the detection of the error). For description purposes, the new data is also referred to as the first data record, and those other data records that were previously created or modified by the Error Detection Module are referred to as second data records. Thus, the error correction process obtains a first data record and a set of second data records in step 2004.

For example to explain a first data record and a second data record, given the case shown in FIG. 19B, the first data record is the pickup of a container from Location B4 and a second data record was created by the Error Detection Module to show that an invisible container, Container Inv_B4, was at Location B4 prior to the pickup. Given the case shown in FIG. 19C, the first data record is the pickup of Container A3 from Location A3, and the second data record is the modified data record (i.e., modified by the Error Detection Module) that indicates that Container A4 is a “ghost” container. If Container A2 instead of Container A3 was picked up at time t3 in FIG. 19C, there would be two second data records: one showing Container A3 as a “ghost” container and the other showing Container A4 as a “ghost” container.

In the embodiment described with respect to FIG. 20, it is assumed that the first data record (i.e., the new data received in step 602) could be wrong itself. Thus, the error detected by the Error Detection Module indicates that there are conflicts (i.e., inconsistency) between the first data record and the second data records. To correct the error, the error correction process needs to first identify which one of the two (the first data record and the set of second data records) is corrupted with the error and needs to be corrected.

Turning now to step 2006, the error correction process next sets search criteria that will be used in the search for error candidates in step 2008; the search criteria include a first search criterion corresponding to the first data record and a set of second search criteria with one second search criterion corresponding to each of the second data record. Each search criteria specifies at least one of the following: container cell locations, a time duration, number of operations, and so on. For example, the search criteria could include the nearby container cell locations within a certain range, operations that occurred within a time period on or about the time the error was detected, container IDs that are close to the container ID associated with the error, container attributes that are similar to the container attribute associated with the error, and so on. The nearby container cell locations could include only the directly adjacent container cell locations if the range is set to be one container size, or all container cell locations that are within a range of two cell locations in any direction if the range is set to two container size. In one embodiment, the range of the nearby container cell locations is determined based on the confidence level of the position data associated with the error; typically the higher the confidence level the shorter the range is. As another example, if the error detected occurred at time tn, the search criteria may require the error correction process to search for operations that occurred during a time period from time (tn−T) to time tn or the last N operations that occurred to nearby container cell locations.

Subsequently in step 2008, the error correction process queries the Inventory Tracking Database 114 using the search criteria determined in step 2006 and reads all the data records in the query results from the Inventory Tracking Database 114. The query results corresponding to the first search criterion are referred to as the first query results and the query results corresponding to each of the second search criterion are referred to as the second query results. The error correction process then continues to step 2010 to examine whether any pre-determined exception rules are met. Examples of the exception rules may include “insufficient data” exception, “no qualified result” exception, “restricted area” exception, and so on. The “insufficient data” exception indicates that the query results do not contain sufficient data for correction; it is satisfied if any of the following conditions is met: (a) the first data record is associated with a pickup operation, but the query results indicate that all cell locations surrounding the pickup location are unoccupied; (b) the first data record is associated with a drop-off operation (or a movement violation), but the query results indicate that all cell locations surrounding the drop-off location (or the movement location) are occupied; (c) a second data record contains an “invisible” container, but its corresponding query results indicate that all cell locations surrounding this “invisible” container are unoccupied; (d) a second data record contains a “ghost” container, but its corresponding query results indicate that all cell locations surrounding the “ghost” container are occupied. The “no qualified results” exception is satisfied if there is neither a “ghost” container nor a “invisible” container in the error candidates and all the error candidates have sufficiently a high confidence level. The “restricted area” exception is satisfied if any error candidate occupies a container cell location that is at a pre-determined restricted area (some areas may be restricted to manual inspection or correction only). Additional exception rules will be explained later with reference to steps 2018, 2020, and 2022.

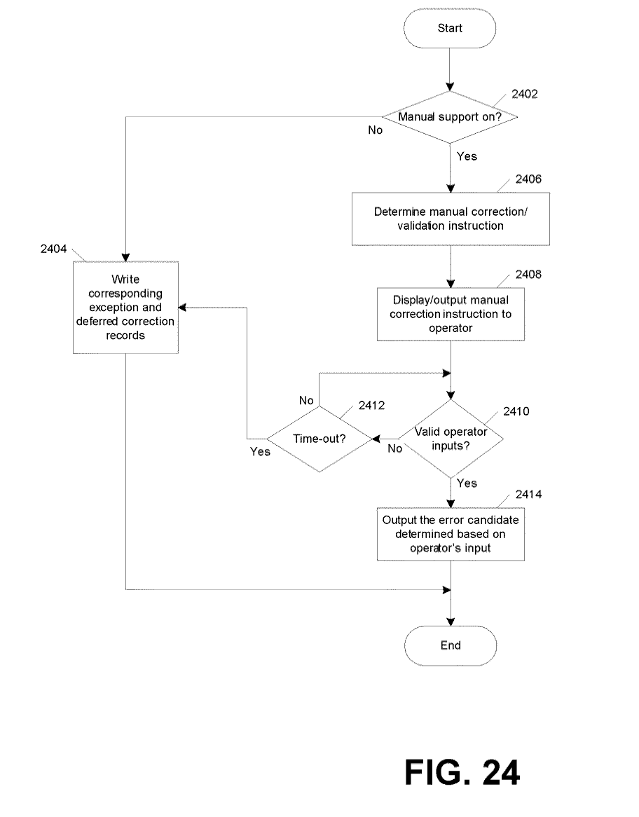

The correction exception process in step 2024 modifies the data records in the error detection results to indicate that a correction exception has occurred together with the exception reason (i.e., which exception rule is satisfied). The correction exception process can also add the corresponding information to the error correction log and/or error detection log. Furthermore, the correction exception process could engage manual support from operators if the manual support function is activated. Such a correction exception process will be described later with reference to FIG. 24.

If no exception rules are met, the error correction process continues to step 2012 to determine error candidates based on the query results. In one embodiment, the error candidates are determined for each data record in the error detection results. First, the first error candidates, i.e., the error candidates for the first data record, are determined based on the first query results. If the first data record indicates a drop-off operation or movement event, the first error candidates include all unoccupied surrounding container cell locations (at the same tier as the first data record); if the first data record indicates a pick-up operation, the first error candidates include all occupied surrounding container cell locations (at the same tier as the first data record). Second, second error candidates for each of the second data record are determined. If a second data record is associated with an “invisible” container (that is, the Inventory Tracking Database 114 shows no container at a location but the first data record indicates that a container should be at the location), its corresponding second error candidates include occupied surrounding container cell locations (at the same Tier as the “invisible” container). In other words, this “invisible” container may indeed occupy its current location but the Inventory Tracking Database mistakenly “placed” it in a nearby container cell location due to errors in the position data. If a second data record is associated with a “ghost” container (that is, the second data record shows a container at a location but the first data record indicates that the container should not be at its location), its corresponding error candidates include unoccupied surrounding container cell locations (at the same tier as the “ghost” container). In other words, this “ghost” container probably should be occupying a nearby container cell location instead of its current location specified in its data record. There are also cases where a second data record shares the same container cell location with the first data record but the second data record shows a container at the cell location while the first data record shows a different container at the cell location. Their difference could be in their container ID and container properties such as length, type, shape, and so on. For example, a second data record show a short container at Location A but the first data record shows a long container at Location A. In such cases, the error candidates for the second data record include occupied surrounding container cell locations whose occupying containers shares the same container ID or container properties as those specified in the first data record. In another simplified embodiment, the error candidates may only include erroneous data records that include either “invisible” containers or “ghost” containers as described with FIG. 18.

In step 2014, the error correction process computes a confidence index (or a conflict index) for each error candidate based on pre-determined formulae to evaluate how likely the candidate could be the source of the error reported from the Error Detection Module 302. As described earlier in step 2012, the error candidates are determined for each data record in the error detection results in one embodiment; correspondingly, the confidence level is calculated differently for error candidates for the first data record and those for the second data records. In this embodiment, the confidence index of an error candidate for the first data record is set to be: k×(1−Conf_{first data}), where Conf_{first data} is the confidence level of the first data record and k is a weighting factor based on the position data recorded in the first data record (i.e., position_{first data}) and the error candidate's container cell location (location_{candidate}), which is typically represented by the position of the cell center. The weighting factor is therefore a function of position_{first data} and location_{candidate}:

k=f(position_{first data},location_{candidate}).

For example, the weighting factor k can be defined as: (d1/2)/d2, where d1 is the distance between the cell center of the first data record (location_{first data}) and the cell center of the error candidate (location_{candidate}) and d2 is the distance between the position of the first data record (position_{first data}) and the cell center of the error candidate (location_{candidate}).

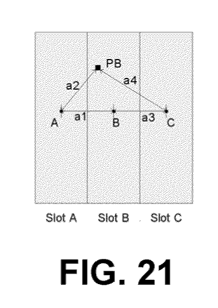

FIG. 21 shows an example to illustrate how the weighting factor can be calculated. The figure shows the top view of the three container cell locations Location A, Location B, and Location C at the same tier, as well as the reported position of Container B (marked as PB in the figure) provided by the positioning system. It is assumed that the first data record indicates an operation at Location B based on position PB from the positioning system and the error correction process identifies Location A and Location C as its error candidates Therefore, the weighting factor for the error candidate, Location A, is (a1/2)/a2 and the weighting factor for the error candidate, Location C, is (a3/2)/a4. In this specific example, the position PB is closer to the cell center of A than to the cell center of C; given that the distances between the cell centers, a1 and a3, are the same, the weighting factor for the error candidate A is larger than the weighting factor for the error candidate C. In other words, the weighting factor is a measure indicating the closeness of the position data to the cell center of the error candidate. As a result, the confidence level for the error candidate A, (a1/2/a2)×(1−Conf(B)), is larger than the confidence level for the error candidate C, (a3/2/a4)×(1−Conf(B)) (where Conf(B) is Conf_{first data} in this example).

Similarly, the confidence index of an error candidate for a second data record is: k×(1−Conf_{error candidate}), where Conf_{error candidate} is the confidence level of the error candidate and k is a weighting factor similar to that used in computing the confidence level of an error candidate for the first data record. For example, k=(d1/2)/d2, where d1 is the distance from the cell center of the error candidate to the cell center of the “invisible” (or “ghost”) container and d2 is the distance from the position of the error candidate to the cell center of the “invisible” (or “ghost”) container. Therefore, the lower the confidence of the error candidate is and the closer the position of the error candidate to the cell location of the corresponding second data record (e.g, the data record containing either an “invisible” or a “ghost” container), the higher the possibility that this error candidate actually should be at the cell location of the “invisible” container or the “ghost” container should be at the location specified by the error candidate.

Returning to FIG. 20, in step 2016, the error correction process determines the potential match(es) for the first data record and the second data records and makes decision regarding whether the first data record or the second data records need to be corrected. The error correction process achieves this by the following sub-steps. (1) For the first error candidates of the first data record, the error correction process sorts their confidence indexes, selects the highest confidence index as a first confidence index, and identifies the corresponding first error candidate(s) as the potential (first) match for the first data record. (2) For each of the second error candidates, the error correction process sorts the confidence indexes of its second error candidates, selects the error candidate(s) that has the highest confidence index as its potential (second) match. If there is only one second error candidate in the error detection results, its potential (second) match's confidence index is regarded as a second confidence index. If the error detection results include multiple second error candidates, an aggregated confidence index is determined by combining the confidence indexes of the potential (second) matches based on pre-determined rules and this aggregated confidence index then serves as the second confidence index. The pre-determined rules could be choosing the smallest confidence index, the mean value, or the medium of the confidence indexes of the potential (second) matches as the aggregated confidence index. The aggregated confidence index could also be a function of the confidence indexes the potential (second) matches. (3) The error correction process then compares the first and the second confidence indexes to determine whether the first data record or the set of second data records needs to be corrected. For example, if the first confidence index is higher, the error correction process concludes that the first data record is incorrect and should be corrected with its corresponding potential (first) match. Otherwise, the error correction process concludes that the second data records need to be corrected. (4) The match(es) for error correction are then determined based on the decision: if the decision is to correct the first data record, the potential first match(es) becomes the identified first match(es); otherwise, the potential second matches are identified as the second matches.

In step 2018, the error correction process examines whether the higher confidence level achieved by the identified match(es) is sufficiently high, e.g., higher than a pre-set threshold. If not, the error correction process may expand the search criteria so that the search could yield a larger set of error candidates; therefore, the error correction process continues to step 2020 to examine whether the search criteria could be expanded (e.g., whether the search criteria already meets or exceeds a pre-set maximum location range, maximum time duration, or ID range). If the search criteria can be expanded, the error correction process continues to step 2006 to update or expand the search criteria and continues with the next iteration from step 2008 to step 2018. If the search criteria cannot be expanded, the error correction process continues to step 2024 to execute the correction exception process with the exception reason being that the confidence level is not high enough.

If in step 2018, the highest confidence level (determined in step 2016) is higher than the pre-determined threshold, the error correction process continues to step 2022 to examine whether there are multiple matches identified for one data record. (That is, step 2022 examines whether there are multiple first matches if the first data record needs to be corrected or there are multiple second matches for any of the second data records if the second data records need to be corrected.) If so, the error correction based on the matches is undetermined and the error correction process continues to step 2024 to execute the correction exception process with the exception reason being undetermined error correction. In some embodiments, arbitration could be used to choose one match from the multiple matches for error correction; if so, the error correction process bypasses step 2024 to continue to step 2026.

In step 2026, the error correction process prepares data records for error correction; its purpose is to generate correct data records based on the identified match(es) and to expire or remove incorrect data records. The detailed process depends on whether the decision is to correct the first data record or the decision is to correct the second data records.

If the decision made in step 2016 is to correct the first data record, the error correction process in step 2026 then corrects the first data based on the first match, invalidates the “invisible” containers in the error detection results by marking them as expired or deleting them, and return s the “ghost” containers “type of container” attribute to “normal” containers. For example, if the first data record indicates a pick-up operation of Container B at Location B and the error candidate of Container A at Location A is determined as the match, the error correction process copies the first data record (which has the Container ID as Container B and the cell location as Location B) to a duplicate data record; it then changes the container ID and container cell location in the duplicate data record from Container B and Location B to Container A and Location A, respectively. The confidence level in the duplicate data record is also updated with the confidence index. With those changes, the duplicate data record is now the corrected data record of the pick-up operation. Subsequently, the error correction process marks the original first data record (which represents the pick-up operation of Container B at Location B) as erroneous (e.g., by setting a “data property” field to “error”) and makes it obsolete (e.g., by changing the value in a “status” field from “current” to “expired” with the current time as the time stamp). In other embodiments, the error correction process can modify the first data directly without creating a duplicate data record and making the original first data record obsolete. Regarding all the “invisible” containers in the second data records, the error correction process corrects them by marking them as expired or submitting a command to the Inventory Tracking Database to delete them. Regarding all the “ghost” containers in the second data records, the error correction process changes their “type of container” attribute back to “normal” with the current time as the time stamp; alternatively, the error correction process could duplicate them first, make the changes, and then marks the original ones as expired or obsolete. In other embodiments, if these second data records were not modified by the error detection module, the above modification may not be necessary.

If the decision is to correct the second data records, the error correction process in step 2026 makes no change to the first data record; instead, it makes corrections in each of the second data records based on its corresponding second match. If a second data record is associated with an “invisible” container, the decision means that the container associated with the match should be at the location associated with the “invisible” container. In this case, the error correction process first creates a duplicate data record by copying the data record of the match; it then changes the location in the duplicate data record to the location associated with the “invisible” container and updates the confidence level to its corresponding confidence index. This duplicate data record then becomes the corrected data record generated by the error correction process. The error correction process then marks the data record of the match, as well as the data record of the “invisible” container created by the error detection process, as erroneous and obsolete with the current time as the time stamp.

Similarly, if a second data record is associated with a “ghost” container, the decision means that the “ghost” container is actually located at the location associated with the match. Therefore, the error correction process first creates a duplicate data record by copying the data record of the “ghost” container; it then changes the location and the confidence index in the duplicate data record to the location and the confidence index associated with the match, respectively. The error correction process further modifies the container properties in the duplicate data record by changing its “type of container” attribute from “ghost” container to “normal” container. With these modifications, the duplicate data record now becomes the corrected data record and the error correction process further marks the original data record associated with the “ghost” container as erroneous and obsolete. If there are multiple “ghost” containers in the error detection results, the error correction process repeats the above process for each of the “ghost” containers.

In step 2028, the error correction process searches and updates records relevant to the match, which includes data records that are associated with subsequent operations that occurred to the container or the container cell location in the match(es). The underlying reason is that the error in the match(es) may have propagated through those subsequent operations. In some embodiments, the first data record (i.e., the new data received in step 602) is input to the Error Detection Module 302 in real time; therefore, the process in step 2028 will be necessary only if the decision is to correct the second data records (since errors in the first data record will not have the chance to propagate yet). The description here assumes that the first data record is input to the Error Detection Module 302 in real time. In other embodiments, the first data record could be historical data that were input to the Error Detection Module 302 much later than when the operation in the first data record occurred; in those cases, the process is needed even if the decision is to correct the first data record and those skilled in the art can extend the description here relatively easily to accommodate those cases.

Accordingly, in step 2028, the error correction processor searches and updates data records relevant to each of the second data records. If a second data record is associated with an “invisible” container, its match is occupied before the correction; therefore, the error correction process compares the time of the last drop-off operation at the cell location in its match and the time of the last pickup operation at the cell location of the “invisible” container (as defined in the second data record). If the drop-off operation occurred before the pickup operation, (which indicates that the drop-off location is actually the location of the “invisible” container,) the error correction process then queries the Inventory Tracking Database 114 for any operation at the cell location of the “invisible” container which occurred after the time of the drop-off operation. For each data record in the query results, the error correction process modifies the container information (e.g., container ID and property) to that of the container in the match. If the drop-off operation is after the pickup operation, (which indicates that the pickup operation actually occurred at the cell location in the match,) the error correction process then queries the Inventory Tracking Database 114 for any operation that involves the “invisible” container after the time of the pickup operation. For each data record in the query results, the error correction process modifies the container information to that of the container in the match.

If a second data record is associated with a “ghost” container, its match is unoccupied before the correction; therefore, the error correction process then queries the Inventory Tracking Database 114 for any operation at the cell location specified in the match that occurred after the last drop-off operation at the cell location of the “ghost” container. For each data record in the query results, the error correction process modifies the container “type of container” attribute to that of the “ghost” container while maintaining the container as a “normal” container (instead of a “ghost” container).

In step 2030, the error correction process updates the Inventory Tracking Database 114 with the modified data records, including the corrected data record generated by the error correction process and the data records (e.g., those containing “invisible” or “ghost” containers) expired by the error correction process. The error correction process can further update relevant history files, such as the error detection log and the error correction log, and tables of “invisible” or “ghost” containers in the Inventory Tracking Database 114.

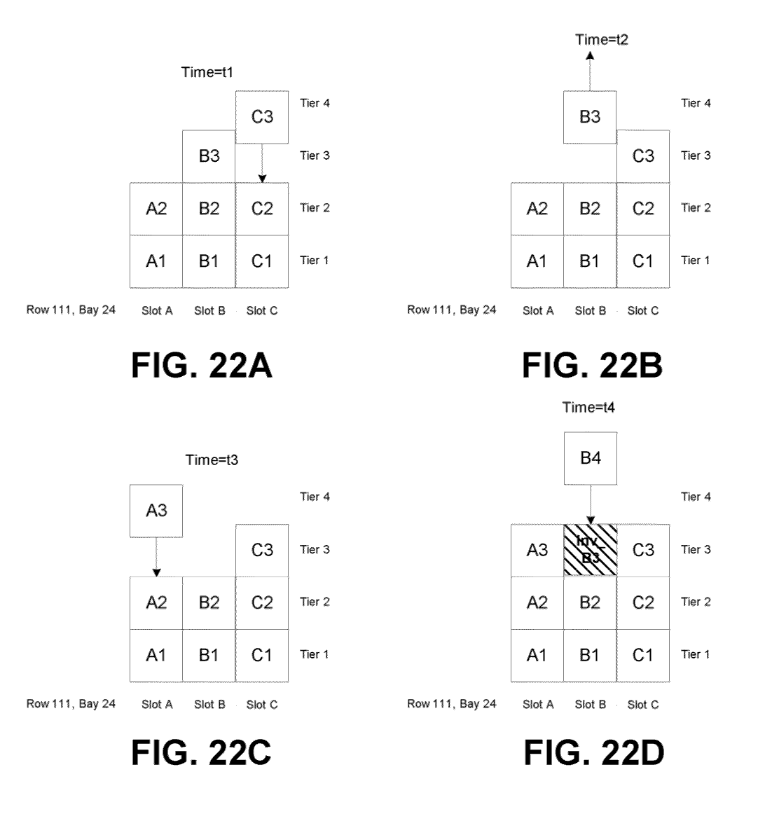

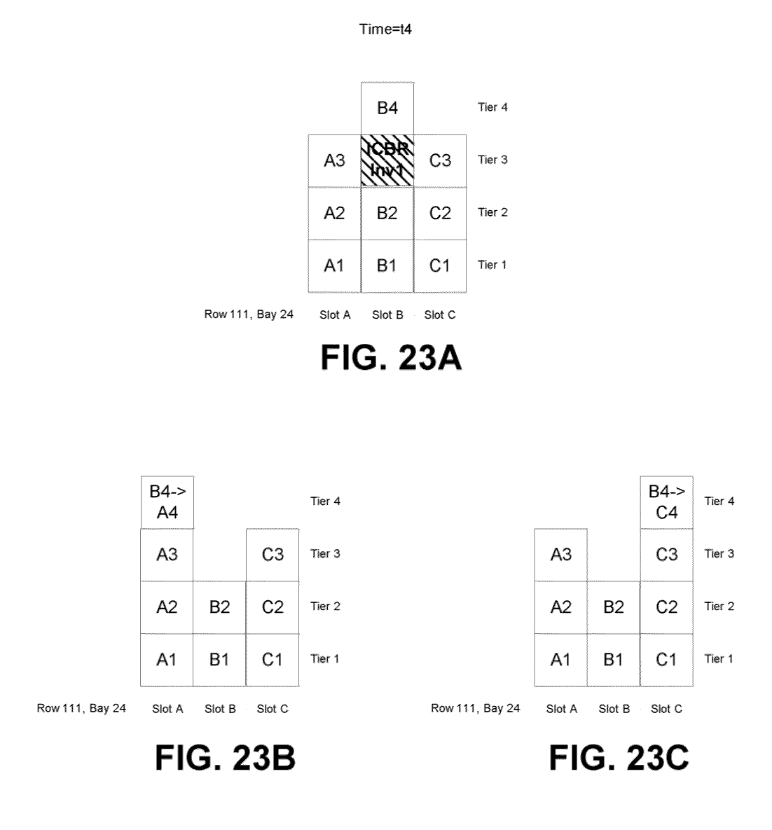

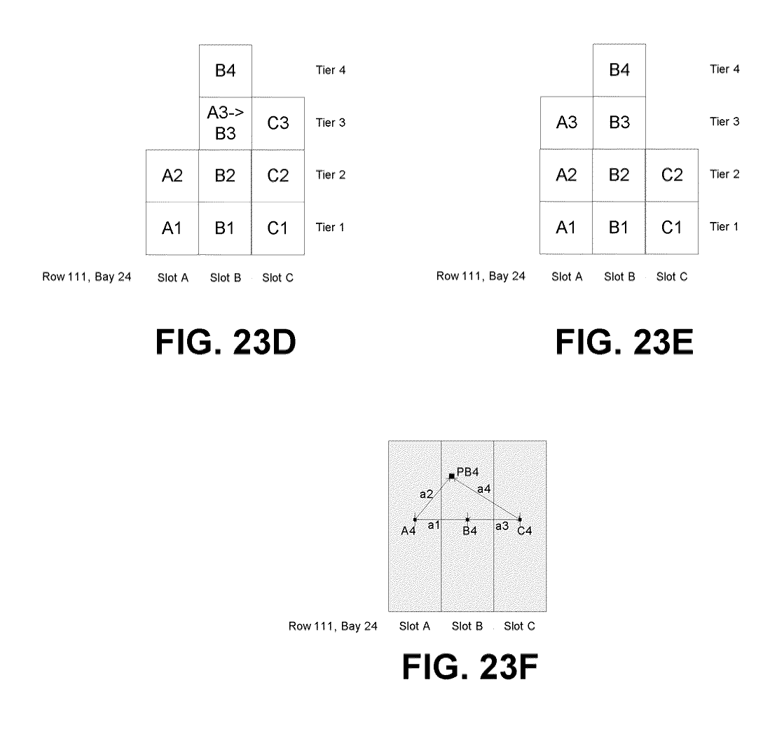

To illustrate how the error correction process described in FIG. 20 works, an example is provided in FIGS. 22A-22D, and FIGS. 23A-23F. FIGS. 22A-22D shows four operations that were carried out at different time instants. Before the first operation at time t1, there are already seven containers, A1, A2, B1, B2, B3, C1, and C2, occupying container cell locations as shown in FIG. 22A. At time t1, Container C3 was dropped off at container cell location, Location C3 (Row 111, Bay 24, Slot C, Tier 3), with a confidence level of Confₜ₁(C3), which could be the confidence level of the position data from the positioning system or a combined confidence level based on both the confidence level of the position data and confidence level of the drop-off event. Accordingly, the Inventory Tracking System creates a new data record to represent the operation; this new data record will include at least Container C3's ID and attributes, the container cell location (Location C3 at (Row 111, Bay 24, Slot C, Tier 3)), the operation type (i.e., drop-off operation), the confidence level Confₜ₁(C3), and the corresponding time t1. Assuming the HE is not operating in an inaccessible location, the Error Detection Module detects no error since the drop-off location was not occupied before the drop-off operation and the drop-off location is not in mid-air (due to the existence of Container C1 and C2 beneath it). Hence, the new data record was added to the Inventory Tracking Database 114 without any modification or correction; accordingly, the Inventory Tracking Database 114 marks the previous data records associated with Container C3 as expired with t1 as the expiration time to indicate that the earlier locations and operations relevant to Container C3 are now obsolete.

Similarly, as shown in FIG. 22B, Container B3 was picked up at time t2 with a confidence level of Confₜ₂(B3), and a corresponding new data record was created with no error detected and the Inventory Tracking Database 114 was updated accordingly. As shown in FIG. 22C, Container A3 was dropped off at Location A3 (Row 111, Bay 24, Slot A, Tier 3) with a confidence level of Confₜ₃(A3) at time t3; again, no error was detected and its corresponding new data record was added to the Inventory Tracking Database. At time t4, Container B4 was dropped off at the Location B4 (Row 111, Bay 24, Slot B, Tier 4) with a confidence level of Confₜ₄(B4) as shown in FIG. 22D. Accordingly a new data record was created for this operation and reported to the Error Detection Module for its examination. Since there was no container at Location B3 (Row 111, Bay 24, Slot B, Tier 3), which is immediately beneath the drop-off location, the error detection process determines that the drop-off location is in mid-air in step 1202 and creates an “invisible” container, Container Inv_B3, at Location B3 through steps 1204 and 1206. The error detection process also computes a confidence level for the “invisible” container. In one embodiment, this confidence level is set to be the confidence level of the operation or event that leads to the identification of the “invisible” container; in the case shown in FIG. 22D, the confidence level of Container Inv_B3 is therefore set to be Confₜ₄(B4). The error detection process first reports the error in step 1215 and then reports the error together with the newly created data record for Container Inv_B3, the data record for the drop-off operation of Container B4 (which is the new data received in step 602 and also the data that leads to the detection of the “invisible” container Inv_B3), and the updated error detection history or log to the Error Correction Module 1702 and the Inventory Tracking Database 114 in step 610.

With the error reported to step 2002 from the Error Detection Module 302, the error correction process receives and reads the error detection results in step 2004; the error detection results include the newly created data record for Container Inv_B3 at Location B3 as the first data record and the data record for the drop-off operation of Container B4 at Location B4 as the second data record. Each data record includes at least the container cell location, the time of the error or the operation (i.e., t4), and the confidence level (i.e., Confₒ(Inv_B3) for the “invisible” container Inv_B3 and Confₜ₄(B4) for Container B4). In step 2006, the error correction process determines the search criteria that will be used to determine error candidates. The search criteria could specify the distance range to the container cell location associated with the error detection results (i.e., Location B3 and Location B4 in this example) based on the corresponding confidence levels or other probability measures, i.e., Confₜ₄(Inv_B3) and Confₜ₄(B4) in this example. The search criteria could also specify the time duration T to limit the search to operations or events that occurred at the container cell locations within the time window from time (t4−T) to (t4) where t4 is the time associated with the error. Alternatively, the search criteria may specify the number of operations or events that occurred to the specified container cell locations. In this example, it is assumed that the search criteria specifies that the distance range to be one container size at the same tier (assuming the confidence level of the height measurement is sufficiently high) and the number of operations or events to be one as well; therefore, based on the first data record, the first search criterion specifies container cell locations at Tier 3 that are immediately adjacent to the container cell location (Location B4) in the first data record; based on the second data record, the second search criterion is determined to include container cell locations at Tier 4 that are immediately adjacent to the container cell location (Location B3) in the second data record. Furthermore, both search criteria limit the search to the most recent operation or event that occurred at each of those adjacent container cell locations.

In step 2008, the error correction process determines the error candidates by querying the Inventory Tracking Database 114 with the search criteria determined in step 2006. To simplify this example, it is assumed that no containers occupy container cell locations in the adjacent bays (i.e., Bay 23 and Bay 22) and no operations have occurred at those container cell locations either. Therefore, the query returns three data records corresponding to: the drop-off operation of Container C3 at t1; the pickup operation of Container B3 at t2; and the drop-off operation of Container A3 at t3. In step 2008, the error correction process reads the three data records in the query results, each of which includes its corresponding container ID and attributes, the operation type, the time stamp, and the confidence level.

In step 2010, the error correction process examines whether any exception rule has been satisfied. Since the query results show unoccupied locations surrounding the drop-off location in the first data record and occupied locations surrounding the “invisible” container Inv_B3, the “insufficient data exception” is not satisfied. It is assumed in this example that the three data records do not have sufficiently high confidence and that the container cell locations at Row 111 Bay 24 are not in a restricted area; therefore, neither the “restricted area” exception nor the “no qualified results” exception is satisfied. As a result, the error correction process continues to step 2012 to determine the error candidates.

In step 2012, the error correction process determines error candidates for the first data record and the second data record. The error candidates for the first data record (which shows the drop-off operation of container B4) represent alternative drop-off locations of Container B4 should the drop-off location reported by the positioning system 104 be incorrect. Thus, the first error candidates for the first data record should include unoccupied container cell locations on the same tier. Since the query results corresponding to the first search criterion indicate that both Location A4 and Location C4 are unoccupied, the first error candidates then include Location A4 and Location C4, as shown in FIG. 23B and FIG. 23C. Similarly, the second error candidates for the second data record (which is associated with the “invisible” container Inv_B3) include occupied container cell locations at the same tier, Location A3 and Location C3, as shown in FIG. 23D and FIG. 23E. In summary, two first error candidates and two second error candidates are found, and the detected error could be resolved with any one of them: (1) Container B4 was actually dropped off at Location A4 as shown in FIG. 23B, (2) Container B4 was actually dropped off at Location C4 as shown in FIG. 23C, (3) the container currently at Location A3 is actually at Location B3, i.e., Container A3 is the “invisible” container Inv_B3 as shown in FIG. 23D, and (4) the container currently at Location C3 is actually at Location B3, i.e., Container C3 is the “invisible” container Inv_B3 as shown in FIG. 23E.

Subsequently in step 2014, a confidence index is computed for each of the four error candidates. According to the description with FIG. 18, in one embodiment, the confidence index of a candidate for the first data record (the drop-off operation of Container B4 in this example) is set to be: k×(1−Conf_{first data}), where Conf_{first data} is the confidence level of the first data record (which is Confₜ₄(B4) in this example) and k=f(position_{first data}, location_{candidate}) is a weighting factor. FIG. 22F shows a top view of the container cell location A4, B4, and B3, as well as the position of the Container B4 (marked as PB4 in the figure) provided by the positioning system. Using the formula: k=(d1/2)/d2, the weighting factor for the error candidate A4 is: (a1/2)/a2 and the weighting factor for the error candidate C4 is: (a3/2)/a4. In this specific example, the position PB4 is closer to the cell center of A4 than to the cell center of C4; given that the distances between the cell centers, a1 and a3, are the same, the weighting factor for the error candidate A4 is larger than the weighting factor for the error candidate C4. As a result, the confidence level for the error candidate A4, (a1/2/a2)×(1−Confₜ₄(B4)), is larger than the confidence level for the error candidate C4, (a3/2/a4)×(1−Confₜ₄(B4)).

Similarly, the confidence index of an error candidate for an “invisible” container is: k×(1−Conf_{error candidate}), where Conf_{error candidate} is the confidence level of the error candidate and k is the weighting factor. Conf_{error candidate} is: Confₜ₃(A3) and Confₜ₁(C3) for the two error candidates, respectively.

In step 2016, the error correction process sorts the confidence indexes and determines a first match for the first data record and a second match for the second data record. For the first data record, i.e., the data record associated with the drop-off operation of Container B4, the error correction process compares the confidence indexes for the error candidate A4 and the error candidate C4 and selects the higher one as the first confidence index. Since there is only one “invisible” container (Container Inv_B3), the error correction process compares the confidence index for A3 and C3 and selects the higher one as the second confidence index. The error correction process then compares the first and the second confidence index and selects the higher one as the highest confidence index. If either the error candidate A4 or the error candidate C4 achieves this highest confidence index, the error correction process concludes that the first data record is incorrect and needs to be corrected; otherwise, the error correction process concludes that the first data record is correct and a container should be occupying Location B3 (i.e., either the container at Location A3 or the container at Location C3 should be occupying Location B3).

In step 2018, the highest confidence index is compared with a pre-set threshold. This example assumes that the highest confidence index is 0.8 and that the pre-set threshold is 0.6; therefore, the error correction process continues to step 2022. It is further assumed that there is only one error candidate that achieves the highest confidence index; thus, the error correction process continues to step 2026. In step 2026, the error correction process prepares data records for error correction. For the completeness of the description, four cases are provided so that each of the four error candidates could be the error candidate that achieves the highest confidence index in one of the cases.

In case #1, the highest confidence index is achieved by the error candidate of Location A4. Therefore, the error correction process copies the first data record (which has the Container ID as Container B4) to a duplicate data record; it then replaces the container cell location in the duplicate data record from Location B4 to Location A4 and updates the confidence level from Confₜ₄(B4) to (a1/2/a2)×(1−Confₜ₄(B4)) (which is 0.8). FIG. 23B shows the effect of these changes, which moves Container B4 from Location B4 to Location A4. The error correction process may further mark this newly created data record to indicate that it is generated by the error correction process as a corrected data record to distinguish it from the data records directly generated by the Inventory Tracking System. As for the original first data record that represents the drop-off operation of Container B4 at Location B4, the error correction process marks it as erroneous (e.g., by setting a “data property” field to “error”) and makes it obsolete (e.g., by changing the value in a “status” field from “current” to “expired” with the current time as the time stamp). The error correction process also marks the data record of Container Inv_B3 as obsolete. In some embodiments, the error correction process may directly make the modifications to the first data record without creating a duplicate data record or report the modified first data record as the corrected data record.

In case #2, the error candidate of Location C4 achieved the highest confidence index; therefore, the error correction process goes through a similar process as in case #1. The only difference is that the corrected data record has Location C4 as its location and the confidence index, (a3/2/a4)×(1−Confₜ₄(B4)) (which is 0.8) as its confidence index. FIG. 22C shows the effect of these changes, which moves Container B4 from Location B4 to Location C4. Similarly, the error correction process marks the original first data record as erroneous and obsolete.

In case #3, the error candidate of Container A3 at Location A3 is identified as the second match since it achieves the highest confidence index; this indicates that the drop-off operation of A3 most likely occurred at Location B3 instead of A3. Therefore, the error correction process first creates a duplicate data record by copying this second match (i.e., the data record of Container A3); it then changes the drop-off location in the duplicate data record from Location A3 to Location B3 and updates the confidence level to its corresponding confidence index. FIG. 23D shows the effect of these changes, which moves Container A3 from Location A3 to Location B3. This duplicate data record then becomes the corrected data record generated by the error correction process. The error correction process then marks the original match (i.e., the data record of Container A3) as erroneous and obsolete. The error correction process further marks the second data record (i.e., the data record of the “invisible” container, Container Inv_B3, created by the error detection process) obsolete with the expiration time as the current time.

In case #4, the error candidate of Container C3 at Location C3 is identified as the second match since it achieves the highest confidence index. Since the drop-off operation of Container C3 occurred at time t1 which is before the pickup operation of Container B3 at time t2, the drop-off location of C3 could not have been at Location B3, which indicates that the pickup operation should have occurred to Container C3 instead of Container B3. Therefore, the error correction process creates a duplicate data record of Container B3, and the error correction process then replaces container ID and properties in the duplicate data record with those of Container C3 and changes the container cell location in the duplicate data record to Location C3. Thus, the duplicate data record becomes the corrected data record which indicates that the pick-up operation at time t2 actually occurred to Container C3 at Location C3. Subsequently, the error correction process marks the second data record (i.e., the data record of Container Inv_B3) as obsolete and changes the data record corresponding to the drop-off operation of B3 from obsolete (or expired) to valid (or current). Thus, the Inventory Tracking Database will have Container B3 still at Location B3. FIG. 23E shows the effect of those changes.

In step 2028, the error correction process queries the Inventory Tracking Database 114 for relevant data records and updates them according to the correction(s). In this example, it is assumed that the new data (i.e., the first data record in the error correction process) is reported to the Error Detection Module 302 in real time; therefore, no query is necessary for case #1 and case #2 since no operation would have occurred to Location A4 or Location C4 yet. In both case #3 and case #4, the match is a match for an “invisible” container. The time of the last drop-off operation at Location A3 and Location C3 is t3 and t1, respectively, and the time of the last pickup operation at Location B3 is t2, which is earlier than t3 but later than t1. Therefore, in case #3, the drop-off of A3 actually occurred at Location B3; the error correction process queries the Inventory Tracking Database for any operation that occurred at Location B3 which is after time t3. The query will return no results and the error correction process continues to step 2030. In case #4, the drop-off of C3 is earlier than the pickup of B3, thus, the pickup at time t2 actually occurred to Container C3 at Location C3. The error correction process then queries the Inventory Tracking Database for all operations that occurred to Container B3 after the pickup operation at time t2. Those operations actually occurred to Container C3 instead of Container B3; therefore, for each data record in the query results, the error correction process changes the container information from that of Container B3 to that of Container C3. By doing so, the error correction process also corrects the error that has already propagated in the Inventory Tracking Database 114.

In step 2030, the error correction process completes the error correction by writing the corrected data records as well as the updated data records to the Inventory Tracking Database. Alternatively, the error correction process may report the correction results to the Error Detection Module 302 to ensure that the correction does not create new errors before updating them to the Inventory Tracking Database. Should the Error Detection Module 302 detect errors in the error correction results, the error correction process can continue to the correction exception process with the exception flag set as “incorrect correction.”

FIG. 24 is a flowchart showing the process involved in one embodiment of the correction exception process in step 1820 and step 2024. This embodiment allows an operator to be involved in the correction process if he or she chooses to enable manual support in the setup. As shown in FIG. 24, the correction exception process starts by checking whether the manual support has been enabled or turned on in step 2402. If the manual support is disabled or turned off, the correction exception process continues to step 2404 to modify the data records in the error correction results to indicate that a correction exception has occurred. For example, the correction exception process could add to those data records an exception flag, whose value was set in previous steps (e.g., steps 1810, 1816, and 1818 in FIG. 18 and steps 2010, 2020, and 2022 in FIG. 20) to represent the corresponding exception rules. The correction exception process can also write the exception rule and time stamp to the error correction log. (As described earlier, the exception rules can include “no sufficient data”, “no qualified results”, “restricted area”, “in-determined match or solution”, “low confidence index”, and so on.)

If the manual support is enabled or turned on, the correction exception process then continues to steps 2406 through step 2414 to engage the operator in the correction exception process to correct the error. In step 2406, the exception correction process prepares instructions for the operator's manual correction or validation; these instructions can include the corresponding exception rule (i.e., the reason for the current exception), all the data records in the error correction results, as well as the data records in the query results. If the exception is due to in-determined match or solution, the instructions will also include all the potential matches that achieve the highest confidence index; if the exception is due to a low confidence index, the instructions will include the match that achieves the highest confidence index. The purpose of these instructions is to provide the operator adequate information related to the error detected and to facilitate the operator's manual correction of the error.

In step 2408, the correction exception process outputs these manual correction instructions to the operator, e.g., through a display. Graphic display or schematic drawings (such as those in FIGS. 22A-22D and FIGS. 23A-23E) could be generated based on the instructions to illustrate the content of those data records, and different color or pattern conventions could be employed to indicate the first data record, the “invisible” containers and the “ghost” containers in the second data records, as well as the error candidates and the matches. The confidence index corresponding to each error candidate can also be displayed beside the corresponding error candidate or show up only upon the operator's request. The correction exception process then waits for the operator's input.

With the information presented, the operator then determines how the error should be corrected by manually examining the information and by engaging other resources available to him or her. Such resources could include images (or information) of the container shipping yard provided by a camera-based monitoring system, such as the one shown in FIG. 14 and FIG. 16 that include cameras 1402, an image processing module 1404, and a communication network 1602. The operator could also contact shipping yard clerks and/or handing equipment operators in the container shipping yard for relevant information. To input the manual correction, the operator could select any of the data records in the display and manually input the correct information regarding the container cell location, the container ID and properties, and so on. The correction exception process could also allow the operator to drag a container from one cell location to another or to remove or add a container at a cell location.

In step 2410, the exception correction process examines whether any input has been entered by the operator, e.g., by monitoring cursor movements or inputs from keyboards. The exception correction process also checks whether the inputs are valid and complete by examining (1) whether the inputs provide a match for the first data record or the inputs provide a match for each of the second data records or (2) whether the inputs correct the first data record or correct each of the second data records. If not, the exception correction process keeps waiting and receiving inputs from the operator until it has waited for a sufficiently long time period (e.g., if the waiting time since the display of the instructions is longer than a pre-determined threshold) as determined in step 2412. In some embodiments, the exception correction process could incorporate the inputs from the operator with the existing information regarding the first and second data records as well as the error candidates to generate possible correction solutions and output those solutions for the operator to select and/or confirm. Thus, the exception correction process may not require the inputs to be complete.

If the correction exception process has waited for a sufficiently long time period without receiving valid inputs from the operator, the correction exception process continues from step 2412 to step 2404 to write the exception rule and modify the data records in the error detection results. Alternatively, if valid operator inputs have been received within the pre-determined time threshold, the correction exception process continues from step 2410 to step 2414 to output back to the error correction process the matches determined based on the operator's input as well as the corrections, if the operator has made specific corrections. Subsequently, the correction exception process exits to step 1824 in FIG. 18 or step 2026 in FIG. 20 of the error correction process. The error correction process then makes the necessary corrections based on the matches selected by the operator or validates the corrections made by the operator in the same way as if the matches or corrections are determined by the automatic error correction.

The embodiments of the error correction process of FIG. 18 and FIG. 20 are described with at least two data records (i.e., the error detection results that include both the first data record and the second data records) as the input, but can also be applied to cases where only one data record is input to the error correction process. In such cases, this one data record is assumed to be incorrect and needs to be corrected. Furthermore, with this single record, the error correction process can be used independent of the error detection process of the Error Detection Module 302. The following description provides such a single-record embodiment following the flowchart shown in FIG. 20.

In step 2002, the error correction process examines whether an error has been reported (from either the Error Detection Module or other modules such as a user interface); if so, the error correction process continues to step 2004 to receive the erroneous data record (which could be error detection results that only include a first data record or a data record input from other modules such as the user interface). This first data record includes at least one of the following information: a container ID, container properties, a position, and a container cell location, and it has been determined to have at least one error in any of the information by either a processor for detecting errors or an operator of the inventory tracking system.

In step 2006, the error correction process sets a search criterion based on the first data record; the search criterion specifies information such as container IDs, container properties, container cell locations, time duration, and the number of operations or events. The error correction process then queries the Inventory Tracking Database 114 using the search criterion and obtains the query results. In step 2010, the error correction examines whether any exception rules are satisfied; if so, the error correction process continues to step 2024 to execute the correction exception process. The exception rules, the examination, and the correction exception process are similar to those described earlier.

If no exception rules are met, the error correction process continues to steps 2012 through 2022 to evaluate the query results and to determine a match for the first data record. The match is a data record in the query results and modifying the first data record based on the match can correct the error in the first data record. In the embodiment shown in FIG. 20, the error correction process determines the match by identifying error candidates for the first data record in step 2012, computing a probability measure, e.g., a conflict index or a confidence index, for each of the error candidates in step 2014, sorting the conflict index to find the highest confidence index and identifying the error candidate(s) corresponding to the highest confidence index as a potential match(es) in step 2016.

In step 2018, the error correction process examines whether the highest confidence index is high enough (e.g., larger than a pre-set threshold) and continues to step 2020 or step 2022 depending on the comparison result. If the highest confidence index is high enough, the potential match(es) is identified as the match(es). If there is only one match (as determined in step 2022), the error correction process modifies the first data record based on the match to correct the error in step 2026. In step 2028, the error correction process searches and updates data records relevant to the first data record or the match as described before. In step 2030, the error correction process updates the Inventory Tracking Database 114 with the corrected data records and writes relevant historic log or error correction log accordingly.

Although the present invention has been described above with particularity, this was merely to teach one of ordinary skill in the art how to make and use the invention. Specific terms such as “invisible” containers and “ghost” containers are used for description purposes; other terms or values could be used to represent containers that may (or may not) be at certain cell locations although the Inventory Tracking Database shows they are not (or are) at those cell locations. Many additional modifications will fall within the scope of the invention, as that scope is defined by the following claims.

What is claimed:

1. A method performed by at least one processor for correcting errors in a container inventory database, the container inventory database stored in a memory device readable by the at least one processor, the container inventory database being associated with a container inventory tracking system of a container storage facility, the method comprising:
obtaining a first data record that comprises at least one of the following information: a container ID, container properties, a position relative to a container, and a container cell location, wherein the first data record has been determined to have at least one error in the information by at least one of the following: a processor for detecting errors in the container inventory database, a processor for detecting errors in the container inventory tracking system, and an operator of the container inventory tracking system;
setting a search criterion based on the first data record, wherein the search criterion specifies at least one of the following information: container IDs, container properties, container cell locations, and a time duration;
querying the container inventory database using the search criterion and obtaining query results;
evaluating the query results to determine a match for the first data record, wherein the match is a data record in the query results, and wherein modifying the first data record based on the match can correct the error in the first data record; and
modifying the first data record based on the match to correct the error and reporting the modified first data record to the container inventory database.

2. The method in claim 1, wherein
the evaluation of the query results further comprises identifying error candidates from the query results and computing a probability measure for each of the error candidates, and
the determination of the match is based on the probability measures of the error candidates.

3. The method in claim 2, wherein the first data record comprises an event type that is one of the following: a container pickup event, a container drop event, and a vehicle movement event, and the first error candidates are determined based on the event type and the first query results, wherein
the first error candidates comprise occupied container cell locations in the query results if the event type is the container pickup event, and
the first error candidates comprise unoccupied container cell locations in the query results if the event type is one of the following: the container drop event and the vehicle movement event.

4. A method performed by at least one processor for correcting errors in a container inventory database, wherein the container inventory database is provided in a memory device readable by the at least one processor, the container inventory database being associated with a container inventory tracking system of a container storage facility, the method comprising:
obtaining a first data record and a set of second data records, wherein a data conflict has been detected between the first data record and the second set of data records;
setting search criteria based on the first data record and the set of second data records, wherein the search criteria comprises a first search criterion corresponding to the first data record and a set of second search criteria with one second criterion corresponding to each of the second data records,
querying the container inventory database and obtaining first query results corresponding to the first data records and second query results corresponding to the set of second data records;
evaluating the first query results to determine a first match for the first data record, wherein the first match is a data record in the first query results, and wherein modifying the first data record based on the first match can resolve the data conflict,
evaluating the second query results to determine a set of second matches, wherein the set of second matches comprises one second match for each of the second data records, and wherein modifying each of the second data records based on its corresponding second match can resolve the data conflict,
deciding whether the first data record or the set of second data records should be corrected by comparing the first match with the set of second matches;
modifying at least one of the following data records: the first data record, the first match, the set of second data records, and the set of second matches, based on the decision; and
reporting the modified data records to the container inventory database.

5. The method in claim 4, wherein
the first data record is provided by at least one of the following data sources: the container inventory tracking system, an inventory management system associated with the container inventory tracking mechanism, an input device for accepting entries from an operator, and a computer program configured to generate the first data record, and
the first data record comprises at least one of the following: a container ID, container properties, a position of handling equipment, a position of a container, and a container cell location in the container storage facility.

6. The method in claim 4, wherein
the data conflict is an inconsistency detected by an error detection method that compares the first data record with data records in the container inventory database; and
wherein the second data records are data records in the container inventory database that are detected to be inconsistent with the first data record.

7. The method in claim 4, wherein
each of the search criteria specifies at least one of the following: container IDs, container properties, container cell locations, and a time duration, and
each of the search criteria is determined based on information recorded in its corresponding data record, wherein the information comprises at least one of the following: a container cell location and a position relative to a container.

8. The method in claim 7, wherein the information further comprises at least one of the following: a time stamp and a probability measure representing a confidence level of the position data.

9. The method in claim 4, wherein the evaluation of the first query results and the second query results further comprises:
determining first error candidates for the first data record based on the first query results and second error candidates for each of the second data records based on the second query results;
evaluating the first error candidates to determine the first match for the first data record;
evaluating the second error candidates for each of the second data records to determine the second set of matches.

10. The method in claim 9, wherein
the first data record further comprises an event type that is one of the following: a container pickup event, a container drop event, and a vehicle movement event; and
the first error candidates are determined based on the event type and the first query results, wherein
the first error candidates comprise occupied container cell locations in the first query results if the event type is the container pickup event, and
the first error candidates comprise unoccupied container cell locations in the first query results if the event type is one of the following: the container drop event and the vehicle movement event.

11. The method in claim 9, wherein each of the second data records falls into one of three categories and the second error candidates for a second data record are determined based on which of the three categories the second data record falls into, wherein the three categories comprise:
a first category if the second data record shows no container at a location but the first data record indicates that a container should be at the location,
a second category if the second data record shows a container at a location but the first data record indicates that no container should not be at the location, and
a third category if the second data record shows a first container at a location but the first data record indicates that a second container at the location, wherein the first container and the second container differ in at least one of the following: container ID and container properties,
and wherein the second error candidates comprise:
occupied container cell locations in the second query results if the second data record falls into the first category,
unoccupied container cell locations in the second query results if the second data record falls into the second category, and
occupied container cell locations in the second query results where the occupying containers share the second container's container ID and container properties if the second data record falls into the third category.

12. The method in claim 9, wherein
the evaluation of the first error candidates comprises computing a probability measure for each of the first error candidates based on the corresponding first error candidate and the first data record, and the first match is determined based on the probability measures of the first error candidates, and
the evaluation of the second error candidates for each of the second data records comprises computing a probability measure of how likely each of the second error candidates based on the second error candidate and its corresponding second data record, and the second match for each of the second data records is determined based on the probability measures of the corresponding second error candidates.

13. The method in claim 12, wherein the probability measure for each of the first error candidate and the second error candidates is determined based on information recorded in the respective error candidate and information in the corresponding data record, wherein the information comprises at least one of the following: a position data, a container cell location, and a confidence level.

14. The method in claim 12, wherein the decision is made by comparing the probability measure of the first match and an aggregated probability measure based on the probability measures of the second matches.

15. The method in claim 4, wherein
if the decision is to correct the first data record, the modification comprises at least one of the following: replacing information in the first data record with corresponding information in the first match, replacing information in the first match with corresponding information in the first data record, and creating a new data record by using information in the first data record and information in the first match; and
if the decision is to correct the second data records, the modification comprises at least one of the following for each of the second data records: replacing information in the second data record with corresponding information in its corresponding second match, replacing information in its corresponding second match with corresponding information in the second data record, and creating a new data record by using information in the second data record and information in its corresponding second match.

16. The method in claim 4, wherein
the decision further comprises exceptions for at least one of the following situations: either the first query results or the second query results are empty, the first match cannot be determined, and any of the second matches cannot be determined,
the method further comprises an exception process before the modification, wherein the exception process prepares and outputs instructions to an operator, accepts and validates inputs from the operator, and determines corrections that need to be made based on the inputs, and
the method modifies at least one of the following data records: the first data record, the first match, the set of second data records, and the set of second matches, based on the corrections determined by the exception process.

17. The method in claim 9,
wherein the first data record further comprises an event type that is one of the following: a container pickup event, a container drop event, and a vehicle movement event;
wherein the first error candidates are determined based on the event type and the first query results, wherein
the first error candidates comprise occupied container cell locations in the first query results if the event type is the container pickup event, and
the first error candidates comprise unoccupied container cell locations in the first query results if the event type is one of the following: the container drop event and the vehicle movement event;
wherein each of the second data records falls into one of three categories and the second error candidates for a second data record are determined based on which of the three categories the second data record falls into, wherein the three categories comprise:
a first category if the second data record shows no container at a location but the first data record indicates that a container should be at the location,
a second category if the second data record shows a container at a location but the first data record indicates that no container should not be at the location, and
a third category if the second data record shows a first container at a location but the first data record indicates that a second container at the location, wherein the first container and the second container differ in at least one of the following: container ID and container properties,
and wherein the second error candidates comprise:
occupied container cell locations in the second query results if the second data record falls into the first category,
unoccupied container cell locations in the second query results if the second data record falls into the second category, and
occupied container cell locations in the second query results where the occupying containers share the second container's container ID and container properties if the second data record falls into the third category.

18. The method in claim 17, wherein
the evaluation of the first error candidates comprises computing a probability measure for each of the first error candidates based on the corresponding first error candidate and the first data record, and the first match is determined based on the probability measures of the first error candidates,
the evaluation of the second error candidates for each of the second data records comprises computing a probability measure of how likely each of the second error candidates based on the second error candidate and its corresponding second data record, and the second match for each of the second data records is determined based on the probability measures of the corresponding second error candidates, and
the probability measure for each of the first error candidate and the second error candidates is determined based on information recorded in the respective error candidate and information in the corresponding data record, wherein the information comprises at least one of the following: a position data, a container cell location, and a confidence level.

19. A container inventory tracking and error correction system, comprising
a container inventory tracking system that tracks containers in a container storage facility, provides inventory data associated with the containers and container handling equipment, and stores the inventory data in an inventory tracking database,
an error detection module provided in a processor that obtains at least one first data record from the container inventory tracking system, identifies an event associated with the first inventory data, provides a list of error types based on the identified event, determines whether an error of any of the error types has occurred, and upon the detection of the error identifies second data records that are related to the error, and
an error correction module provided in the processor that, upon the detection of the error, obtains the first data record and the second data records, sets search criteria based on the first data record and the second data records, queries the inventory tracking database with the search criteria, obtains query results, determines a first match for the first data record and second matches for the second data records from the query results, makes decision regarding whether the first data record or the second data records need to be corrected by comparing the first match with the second matches, modifies at least one of the first data record and the second data records based on the decision, and reports the modified data records to the inventory tracking database
